(19) United States
(12) Patent Application Publication
(10) Pub. No.: US 2007/0067371 A1
(43) Pub. Date: Mar. 22, 2007

(54) Database structure and method

(75) Inventors: Bruce G. Allan, Lafayette, CA (US); Yeow Loong Lee, Saint Louis, MO (US); J. Neil Cobb, Plano, TX (US); Heather R. Bosley, McKinney, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P., Reno, NV (US)

(21) Appl. No.: 11/230,015

(22) Filed: Sep. 19, 2005

(51) Int. Cl. G06F 17/30

(52) U.S. Cl. 707/206

(57) ABSTRACT

The present disclosure is directed generally to a system and method for content management. The system and method provides a rhetorical content model, and automated methods of generating proposals and other documents based thereon. The data storage system can map properties from an explicit data architecture to constructs in a liquid content abstract data architecture. The mapping is performed based on rules such that the level of abstraction is increased from normal database architectures. In a particular illustrative embodiment, the content management system includes a database including a plurality of records and a server responsive to the database. At least one of the plurality of records includes a plurality of fields storing grammatical syntax elements associated with a content subject. Each of the grammatical syntax elements has a rhetorical structure to facilitate selective assembly into at least one sentence. The server is configured to selectively retrieve at least one of the grammatical syntax elements and to provide a data file including the selectively retrieved grammatical syntax element.

### COPYRIGHT NOTICE

A portion of the disclosure of this patent document contains material to which a claim of copyright protection is made. The copyright owner has no objection to the facsimile reproduction by anyone of the patent document or the patent disclosure as it appears in the Patent and Trademark Office files or records, but reserves all other rights whatsoever.

### FIELD OF THE DISCLOSURE

This disclosure relates, in general, to database configurations and to a database structure and method that can organize and link rhetorical building blocks.

### BACKGROUND

Documents and displayable media such as advertising materials contain “content.” Different content has different purposes, different formats, and different subject matter. Content that has meaning and purpose is typically referred to as rhetorical content. Most businesses strive to provide a consistent image for all media materials. Content management may be useful in providing a consistent product description in advertising materials across multiple sales and marketing mediums such as websites, proposals, brochures, and other documents. In a typical business environment, content from past efforts cannot be reused because of many factors. Managing content is a significant challenge for businesses, creating significant costs for large multi-department organizations. Content re-use issues are made more difficult by variances in regional product availability, audience type, and target marketing. Thus, re-occurring creation and delivery of high quality content to customers and clients is often inefficient and expensive. As such, expenses increase as content is manually adapted or edited for various uses and formats. Accordingly, it is difficult for business and organizations to efficiently create content that is consistent, accurate, and readily available for re-use.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 depicts an exemplary embodiment of a content management system;

FIG. 2 depicts an exemplary embodiment of a rhetorical content delivery system;

FIG. 3 illustrates an exemplary embodiment of a content input tool;

FIGS. 4A through 4O depict an exemplary logical data model diagram for organizing and relating content by rhetorical elements;

FIGS. 5A through 5O illustrate an exemplary physical data model for organizing and relating rhetorical content in a database platform;

FIGS. 6A through 6J depict an exemplary explicit model for an abstract database schema;

FIGS. 7A through 7J illustrate an exemplary logical meta-rules mapping model of a database schema;

FIGS. 8A through 8H provide an exemplary explicit model mapping for a discourse object;

FIG. 9 is an exemplary mapping table for relating an explicit model data object with an abstract model data construct;

FIG. 10 is an exemplary flow diagram of a method for entering data into a database; and

FIG. 11 is an exemplary flow diagram of a method for producing rhetorical content from a database.

### DETAILED DESCRIPTION OF THE DRAWINGS

The present disclosure is directed generally to a content management system having a database containing classes of linkable rhetorical building blocks. Responsive to minimal user input, the rhetorical building blocks can be assembled into terse sentences that are fluent and coherent, and project a quality image.

Conventional content management systems and methods view content as “chunks” of contiguous text often forming a paragraph interspersed with graphical objects in accordance with good writing style. These chunks typically contain an all inclusive theme or idea. These chunks also tend to be the smallest element or building block of the content management system.

Often, this “self contained/all inclusive concept” chunk is stored in a file or folder of a computer not readily accessible to anyone but the creator of the chunk. Frequently this compilation is stored in an ad hoc manner irrespective of any underlying meaning or purpose.

Further the chunks typically contain “fixed content” with an application specific computer program that has a proprietary format. For example, one marketing department may store the chunks in a Windows Words® document, while another marketing department may store chunks in a specialized publishing format. These methodologies severely limit the re-usability of the content. “Repurposing” content (i.e. reusing the content in a different context or for a different purpose) is virtually impossible with conventional configuration and methodologies.

In a particular illustrative embodiment of the present disclosure, a memory is configured to store at least one discourse object, a plurality of concepts, and a plurality of properties, the plurality of properties having a linkable rhetorical structure. An association structure is configured to associate at least one property from the plurality of properties with a concept from the plurality of concepts and to couple the at least one discourse object to the individual properties responsive to a selectable concept.

In the data storage system, discourse objects, concepts, and properties, from an explicit data architecture can be mapped into constructs using a liquid content abstract data architecture based on rules such that the level of abstraction is increased. The discourse object, concept, and/or property, can be stored responsive to a rules table. When new entries are added to the data storage system, new instances may be added to existing rules tables.

In one configuration, the content management system includes a data storage system (e.g., a database) that provides memory configured to store at least one object that may be a “discourse object.” The system can also store a plurality of concepts. A concept can be a sentence that has interspersed variables. The variables may be locations in the sentence where “properties” can be plugged in, to form a complete sentence. The properties can efficiently give meaning to a discourse object.

In practice a relational database can be utilized to link the stored properties or subject matter with the discourse object. A plurality of concepts can be organized by their meaning or “intent to convey” a specific theme or idea about the discourse object. Further, the concepts can be linked to a plurality of properties such as descriptions, differences, or other rhetorical based content that will provide information associated with the discourse object.

In one embodiment a discourse object can be a user-defined entity or something to be described. In the examples described below, the discourse object is something that a business provides to customers such as a product, or a service. Other examples of possible discourse objects may include, for example a person, a country, a government, a sales promotion, a product offering, a service offering, a package offering, and/or any thing that can be described. “Concepts” may be used as a mechanism to convey a certain thought or meaning to an audience. The concept may be conveyed, for example, utilizing another class of data such as properties.

In accordance with the teachings of the present disclosure, discourse objects, concepts, and properties represent rhetorical building blocks. Rhetorical building blocks stored in an application such as an extensible mark up language (XML) application can provide a database that has “liquid content.” The liquid content format of the present disclosure allows rhetorical units to be automatically linked or concatenated. For example the discourse objects may be linked with properties based on a selected concept. The assembled liquid content can provide a grammatically correct, informative, and persuasive passage. A database facilitating the liquid content may have association structures, links, or relationships that are configured to associate a specific discourse object with a property type and a concept type in response to minimal user input.

Discourse objects that are similar can often utilize similar concepts and descriptive content. However, in accordance with the present disclosure, it may not be necessary to enter similar descriptive content more than once in a database. The liquid content data architecture disclosed herein may not only eliminate unnecessary redundancy, which significantly reduces rework and content maintenance difficulties, but it may also provide a great deal of control over the level of content re-use.

A method incorporating the present teaching may also provide control over the specific items to be re-used by a content writer in any particular situation. In one configuration, the liquid content abstract data architecture treats all types of descriptive facts as a well-defined and concentrated set of data structures that can be manipulated in a common way. With such a database structure, reuse of the content can be managed by a front end of the application in a very generalized process.

In one configuration, a discourse object can be placed in a complete and rhetorically focused sentence in response to a user selecting a discourse object and a concept. The concept may be selectable from a class of concepts or from a plurality of classes of concepts or classes of information. For example, the concept may be a meaning, a purpose, a persuasion, a conveyance, an intent, a concept, or an example.

Properties may include rhetorically based text that can help describe something about a selected discourse object. A property may be a comment, a description, an opinion, a testimonial, a difference, or something to convey regarding the discourse object. A property can also be rhetorical content that can convey a theme or an idea about the discourse object via the selected concept. The concept, and a property that supports the concept, can be also be linked utilizing a target audience classification. The target audience links can determine a language type and a technical level and assemble content based on such a link.

In accordance with one methodology for setting up and maintaining a system, a user/administrator can enter a discourse object as a text element, and a plurality of grammatical structured properties such as rhetorical sub-structure elements. In operation, the grammatical structured properties can be associated or linked with content classifications to provide grammatically correct content. The system may store the plurality of grammatical structured properties as text elements in a data record associated with the content subject; converting at least a portion of the data record into a structured format file supporting the rhetorical elements. The stored content can then be rendered electronically and printed as a document using the structured format file.

In some embodiments, a content storage and retrieval application can include a gateway program configured to receive requests associated with a discourse object for rhetorical data files. The rhetorical data files can include a tag-separated data structure wherein the tags can identify a set of grammatical phrase structures. A parser can be configured to selectively construct content utilizing at least one grammatical phrase structure and place atomic level rhetorical units into the phrase where appropriate.

In a further embodiment, an automated method of building rhetorical content from a relational database that contains atomic rhetorical elements organized by their meaning and effect on a predetermined audience is provided. The method can include retrieving a first rhetorical element from a database, retrieving a second rhetorical element from the database and constructing a sentence by combining the first rhetorical element and the second rhetorical element, wherein the sentence has a purpose and message selected by a user.

In yet a further embodiment, a rhetorical content model is disclosed. The rhetorical content model includes a first computer retrievable grammatical syntax element associated with a rhetorical structure and a second computer retrievable grammatical syntax element associated with the rhetorical structure. The rhetorical structure facilitates selective assembly of the first computer retrievable grammatical syntax element and the second computer retrievable grammatical syntax element into a sentence.

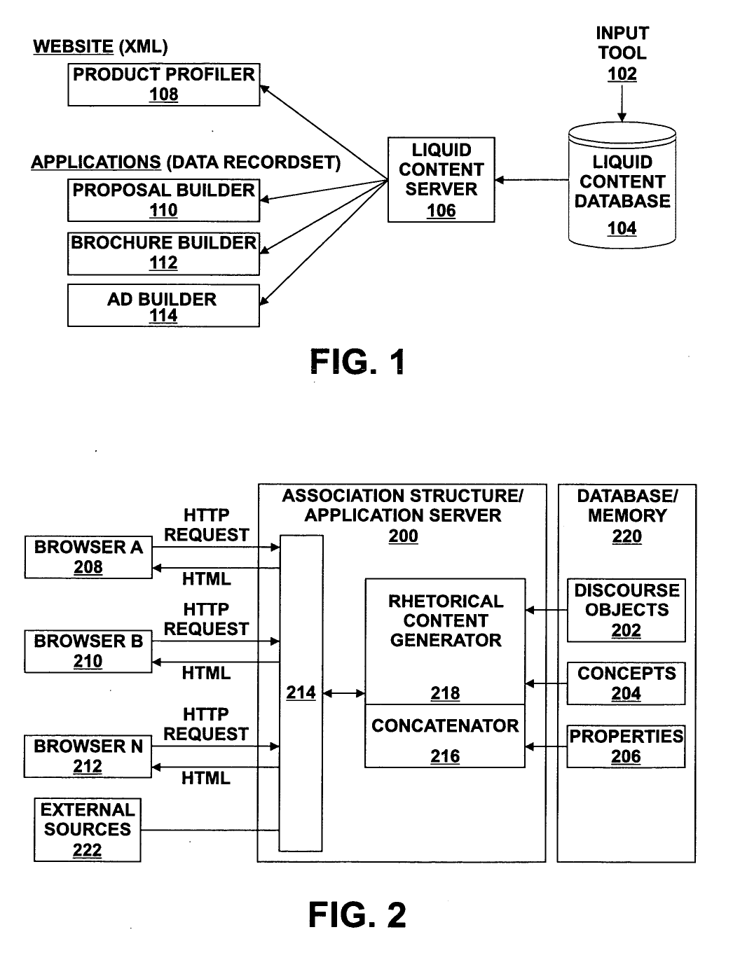

As mentioned above, FIG. 1 depicts an exemplary embodiment of a content management system that utilizes a liquid content database. The content management system includes a liquid content database 104 and a liquid content server 106. In addition, the content management system may include an input tool 102 and various applications 108, 110 112 and 114.

The input tool 102 can be utilized to receive content segments or rhetorical units and store those segments in the liquid content database 104. The content segments are not necessarily limited in form or substance and may, for example, be words, sentence fragments, phrases, nouns, partial sentences, complete sentences, graphics, legal disclaimers, and/or complete paragraphs. In one exemplary embodiment, sentence fragments having rhetorical content may be entered. These sentence fragments may have a specific grammatical format and fulfill a specified rhetorical purpose.

Utilizing the rhetorical format, parts of a sentence may be gathered, stored, and associated in tables and in fields within tables in the liquid content database 104. Rhetorical principles may control the development of sentence syntax from the grammatical elements and drive the deployment of the content based on the communication or messages that the writer/author/user wants to convey.

Liquid content database 104 may be realized in many different physical configurations that can be implemented by many different physical platforms. For example, programs such as Oracle® or SQL Server may be utilized to configure and operate the database and provide the application layer. The embodiments and descriptions herein should not be utilized to limit the scope of the present disclosure. The “logical configurations” described herein may be modified to operate on most known database platforms.

The liquid content database 104 may store records, tables and/or file references. These records, tables, or files may be linked to other records, tables, and/or files forming a relational database. Each record or table may have fields that can be associated with a content subject that again may have a plurality of fields. Records, files, and tables can link to one file or to many files. This link relationship may be referred to as cardinality. Fields may contain words, sentence fragments, phrases, complete sentences, paragraphs, or any combination thereof. Content substructures stored in fields may be selectively used to construct content associated with a selectable discourse object.

The content server 106 may have the ability to access records that associate discourse objects with properties via a selected content subject. Applications such as product profiler 108, proposal builder 110, brochure builder 112 and ad builder 114 may request the content server 106 to provide content associated with a discourse object. The content server 106 may access the liquid content database 104 to selectively retrieve requested fields from the tables or records. The content server 106 may provide the content elements in various formats, including a universal data record set or an extensible mark-up language (XML) format.

The applications 110-114 may construct content using various formats or models. Some of the fields in the records may, for example, follow a rhetorical model. In this example, the model utilizes sentence elements having a specific grammatical form designed to meet a particular rhetorical or communication function. The sentence elements or grammatical syntax rules may be used to construct a sentence. In one exemplary embodiment, the rhetorical model may be used to form a sentence having three elements, a product name, product class, and product description as shown below.

Thus, one concept type “DEFINE PRODUCT” may provide the rhetorical-communication function to define a product where “product name” would be a discourse object and “product class” and “product description” would be properties as follows;
<<Product name>> is a <<product class>> that <<product description>>.

To produce a grammatically correct sentence, the elements may follow specific grammatical forms. For example, if the product name may be a noun, the product class may be a noun that agrees with the singular verb “is,” and singular article “a,” and the “product description” may be a phrase beginning with a third-person singular active verb. A populated concept type may be include;
<<A chair>> is a <<piece of furniture>> that <<has four legs, a platform for sitting, and a back to lean against>>.

Viewing the example above, it can be seen how “atomic” rhetorical building blocks can be stored in the liquid content database 104 based on their meaning or rhetorical classification. Fields within the database tables that are associated with content subjects may store grammatical syntax elements that structure the sentences based on one or more rhetorical formats such as tense etc. Rhetorical formats utilized herein can also include context such as the ability to persuade by appealing to reason, emotion, and/or character. Thus, an automated process for providing a grammatically correct sentence that has a strong and clear presentation can be provided by assembling elements retrieved from the liquid content database 104.

In one embodiment, the product name and product class may be used to make an informative sentence. In another embodiment, the product name and product description may be used to build a different sentence. Alternately, the product name may use other rhetorical elements to build a third sentence. Additionally, a different product name can be utilized with the product description above. Thus, “atomic level rhetorical building blocks” stored in the fields of the liquid content database 104 can be re-used autonomously or near autonomously to provide eloquent content for many different sentences.

In addition, fields within the tables may be utilized to store phrases, sentences, or paragraphs that are linked to concept types to fulfill a specified rhetorical/communication function. For example, fields may store teaser sentences, point statements, illustrative descriptions, analogy statements, and feature statements. Sentences or phrases may relate to additional differentiators such as differentiating details including physical or conceptual differences between products in a class, comparisons with older technologies, and examples of functional differences, inventories, and analogies. In another example, a point statement may be included that further describes the product such as an advantage or a specific usage that will target a special audience or provide a focused “point of view.”

The database 104 may further store contexts in which a content or content element is applicable. For example, content elements relating to the same content subject may be provided for different markets, audiences, regions, and/or branding efforts. In one exemplary embodiment, different legal statements may be provided as a building block. Since the law may vary by jurisdiction, a legal disclaimer may be retrieved from the database specific to a region in which the content will be provided to a consumer.

In another example, different content elements may be provided when marketing to different target markets. In a further example, different content elements such as product names may be associated with a content subject for different branding efforts. Different content elements may be provided for various perceived audience technical comprehension levels as well.

In one exemplary embodiment product profiler 108 may support web page data formats allowing content to be assembled and provided in a document, flash file, PDF, or other electronic format.

In the database, the properties may also be linked to fields storing grammatical syntax elements. In one embodiment, each of the grammatical syntax elements may support a rhetorical structure (i.e. atomic level excerpts having a format the is universally linkable to words or other rhetorical structure having the proper tense etc.) As such an auto-generated sentence may have the intent and purpose and punctuation desired by the user.

In one configuration, data or instructions required to create such content can be stored externally. Source identifiers for external references can be utilized to locate executable code, rhetorical units, graphics, and/or other building blocks. When a discourse object is selected and a concept or rhetorical theme is selected, rhetorical units that relate to discourse objects can be concatenated to provide a rhetorical passage. Thus, a rhetorical passage can automatically be assembled and displayed responsive to minimal user input. Additional user selections such as that of a target audience can be made to change for example, the language, the technical level, and/or the grammatical level of the rhetorical passage.

In operation, the liquid content database 104 may store a plurality of records that include a plurality of linked fields. Grammatical syntax elements can be stored in the fields such that proper syntax can be ensured when content is assembled. Each of the grammatical syntax elements may be associated with a rhetorical rule and rhetorical structure to facilitate selective assembly of the fields into at least one sentence or paragraph. Liquid content server 106 may be configured to selectively retrieve at least one of the grammatical syntax elements and provide a data field that includes the selectively retrieved grammatical syntax element.

Each of a plurality of grammatical structured text entry elements may have a rhetorical structure such as specific verb tenses to facilitate selective assembly of the “atomic rhetorical elements” into at least one sentence. In one embodiment, the database is structured into formatted files and records that include a plurality of grammatical structured text entry elements organized by rhetorical features. The liquid content server 106 can then concatenate the files, fields, or records, based on user input to produce content with rhetorical purpose.

In one exemplary embodiment, the content management system may be integrated with an enterprise architecture. An application may reside on a user end of the architecture while content server 106 and database 104 may reside in a business services section. In other embodiments, the system may be implemented on an Internet or an Intranet and use browser technology. The entire system could also be resident on a single personal computer.

FIG. 2 depicts an exemplary application for creating content having rhetorical purpose. In this exemplary embodiment, a website environment is described that provides the database application to many users via browsers. The pages of the website formulated by the browser may automate the creation of rhetorical content responsive to user selected elements that can be retrieved from a database 220.

An application server 200 may receive requests from user-operated browsers 208, 210, and 212. In response to some user input, server 200 may output a selected discourse object. The application server 200 may have a gateway program 214 that acts to receive the requests and provide output to the browsers 208, 210, and 212. In an exemplary embodiment, gateway server 214 receives HTTP requests and provides HTML web page content; however, the present teaching is not limited to any particular format or system configuration.

Database 220 may be configured to store, organize, and link records by discourse objects 202, concept types or concepts 204, and/or properties 206. As discussed above, discourse objects 202 can be a product or service or any item, idea, or entity, to be described. Concepts can be a rhetorical purpose, such as an argument that appeals to emotion for purchasing and/or anything that can explain, support, or add substance to the discourse object. The concept may also be a “how”, a “why”, a “what,” a “where”, and/or a message related to the object. A subset of concept types may include a meaning, a purpose, a persuasion, a conveyance, an intent, a concept, an example, an illustration, a testimonial, a definition, a description, a comparison, an emphasis or an inference, an advantage, an application, an availability, a component, a customer input, a customer question, a diagram, a differentiator, a feature, a how does it work explanation, an implementation, an example, a configuration, an opinion, a success story and/or a legal note.

Properties can be descriptions, differences, comments, opinions, testimonials, names, dates, events, graphics, occurrences, differences, a who, how, when, why, where, and what regarding any number of content and discourse object selections. Generally, a property can be considered as a textual building block that can help describe something about or convey a theme, idea, and/or a concept about a selected discourse object.

The concept and the properties that support the concept can be further refined or organized for a target audience, wherein the target audience can be selected and properties can be provided by the application server 200 responsive to the user selected audience. In this manner, content elements associated with a content subject may be reused in various contexts or for various purposes. As such, the content elements may be re-purposed and utilized automatically responsive to minimal user input.

In database 220, properties 206 may include fields storing grammatical syntax elements. In one embodiment, each of the grammatical syntax elements support a rhetorical structure (e.g. atomic level excerpts having a format the is universally linkable to words or other rhetorical structure having the proper tense etc.) When user input facilitates selective assembly of records into at least one sentence, the sentence can have the intent and purpose desired by the user. The properties may be stored in rhetorical units such that when a discourse object, a concept, and properties are selected, a concatenator 216 can automatically concatenated the selections to provide grammatically correct, informative, eloquent, and persuasive passages.

Upon receiving a user request for content, the gateway program 214 may prompt rhetorical content generator 218 to locate and retrieve files having properties that are most likely to provide at least one concept associated with the selected discourse object.

The files may be in XML format and the XML files may have tags that identify the elements. The XML files may be interpreted by concatenator 216 such that the sentence conforms to quality grammatical structure. The XML files may be associated with a document type definition (DTD) file and further interpreted in accordance with DTD standards. The application server 200 may also include an extensible stylesheet language (XSL) file as interpreted by an XSL processor. Together, the rhetorical content generator 218 and the concatenator 216 can provide content elements to the gateway program 214 based on a user selected discourse object and a selected concept. The gateway program 214 may further assemble the content elements into browser compatible formats such as “web page” formats.

The rhetorical content that can be assembled utilizing the disclosed liquid content database structure may be nearly limitless. For example, a user may want to create content that includes a “product” as the discourse object. In one case, a product definition rhetoric may be created under the concept “descriptions.” Another concept for the same “product” may be “Operation.” For example:
A/An <<OPERATION>> occurs when <<STIMULUS>> causing <<REACTION>> resulting in <<OUTCOME>>.

Yet another example concept may be “Analysis”;
There are <<NUMBER>> main types of <<TERMS>>: <<TYPE 1>> which are [used/based on] <<USE-1 FUNCTION-1>> and <<TYPE-2>> which are[used/based on] <<USE-2/FUNCTION-2>>.

Another concept may be “Differentiation”;
<<Product name>> is a <<product class>> that has <<a key differentiator>>.

The liquid content database 220 can be very flexible in creating a specific output. For example, database 220 may be structured to store “product names” as discourse objects and “product classes” and “key differentiators” as properties. The product name, product class, and key differentiator may each have a specific grammatical syntax that permits their use in this rhetorical structure, while allowing them to be used together or separately by other grammatical structures that serve similar or even widely different rhetorical/communication purposes in other applications.

To produce a grammatically correct sentence, the elements and records in database 220 may follow specific grammatical forms as is described above. Each browser may utilize different elements derived from the grammatical syntax fields stored in the database 220 and transfer the request to the gateway 214 in an XML file. In this manner, the content elements link properties with a selected discourse object in accordance with the intended purpose of the user. External references or external sources 222 such as an external database can also be utilized by the disclosed method.

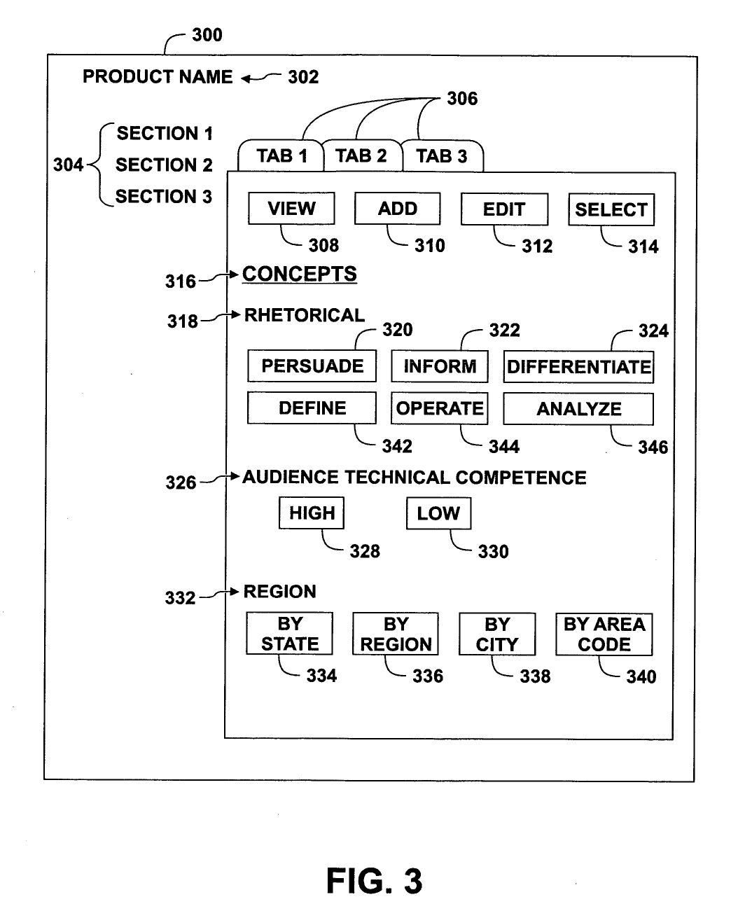

FIG. 3 depicts an exemplary user interface or input tool for entering data into or for retrieving data from the liquid content database 220 of FIG. 2. In this exemplary embodiment, the discourse object is a product as denoted by the product name 302 at the top of the interface page 300. In the described embodiment, the user interface 300 may be provided by a browser application and be displayed as a web page.

In the illustration, properties or data associated with a product are subdivided into sections 304. Each section may have an associated entry page within the displayed page. The sections 304 may, for example, be subdivisions associated with what a product does, how it works, what it is, general information, branding information, frequently asked questions associated with the product, teasers, product features, advantages, applications, implementation, success stories, components, diagrams, options, availability, legal notices, white papers, and/or other information.

The interface page 300 may be further subdivided into tabbed sections that define certain grammatical structures for a particular content. These subdivisions can be accessed selecting tabs 306 as soft buttons. These tabbed sections may be displayed as individual web pages and each section may have multiple tab pages associated with different web pages. In addition, each page may include a selectable element such as a selectable soft button. The interface page 300 may include buttons such as a view button 308, add button 310, select button 314, and edit button 312. The view button 308 may facilitate a display of content associated with the product name 302. The add button 310 may allow a user to add content into a record in the database. The edit button 312 may, for example, unlock text entry fields, permitting editing of text associated with the content elements. Alternately, other buttons may be used to manipulate data, records, and links within the database.

In an exemplary embodiment, different concepts that can be selected are illustrated. Rhetorical concept 318 includes persuade button 320, inform button 322, differentiate button 324, define button 342, operate button 344, and analysis button 346. The operation associated with the define button 342, the analysis button 346 and operation button 344 can be understood when referring to the rhetorical content examples above.

Audience level 326 includes a high technical level button 328 and a low technical level 330. Region concept 332 includes a by state button 334 by region button 336 by city button 338 and by area code/address button 340. The buttons illustrated are a small subset of what could be available for selection and this illustrative embodiment should not be utilized to limit the scope of this teaching. Thus, an author/user can select a discourse object such as product, then select the concepts to be applied to the discourse object and the system and method can provide structured and fluent rhetorical content when requested by a user.

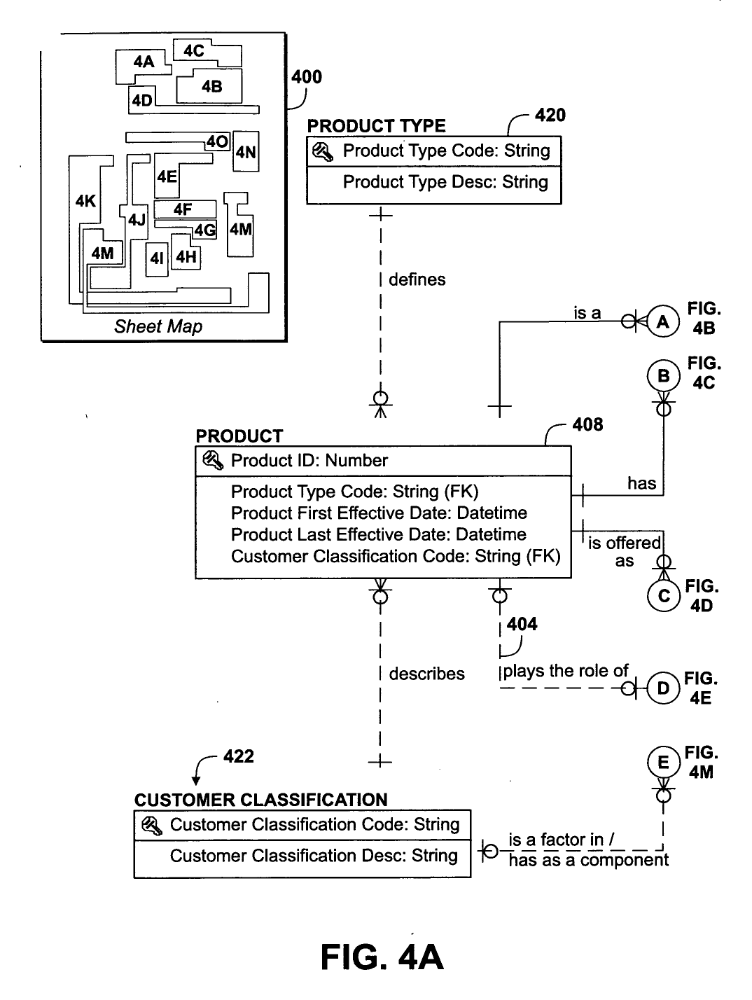

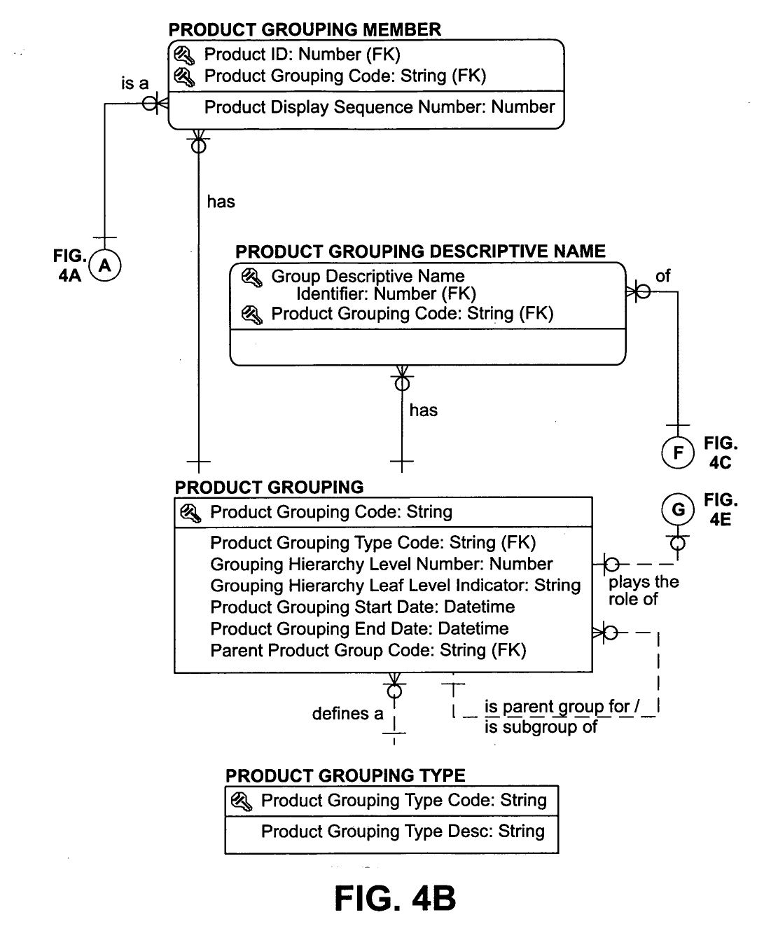

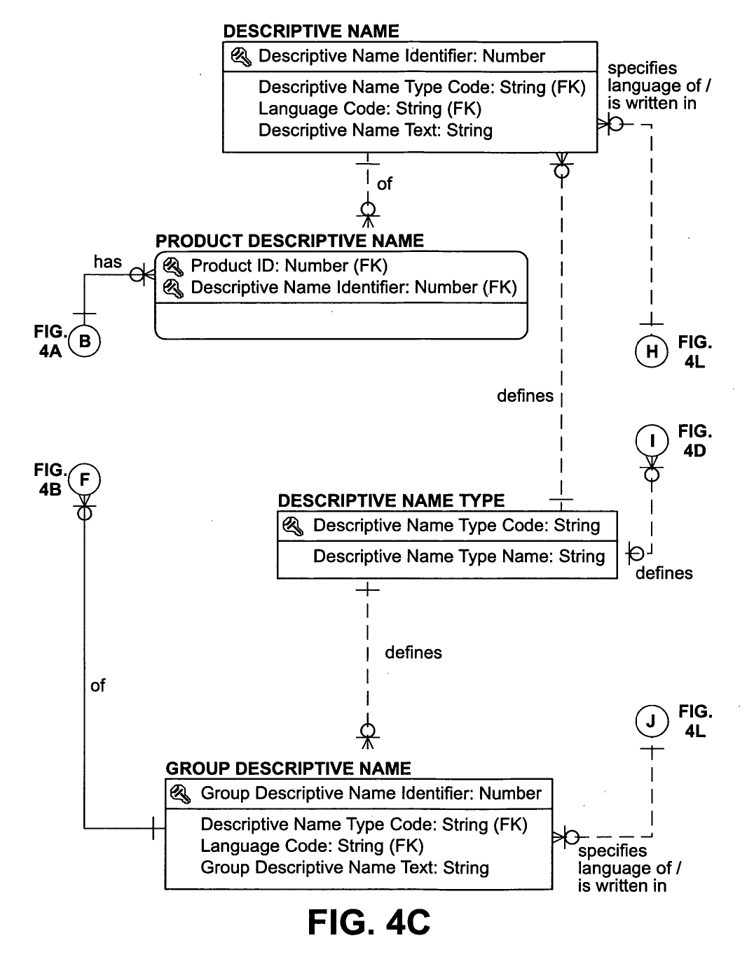

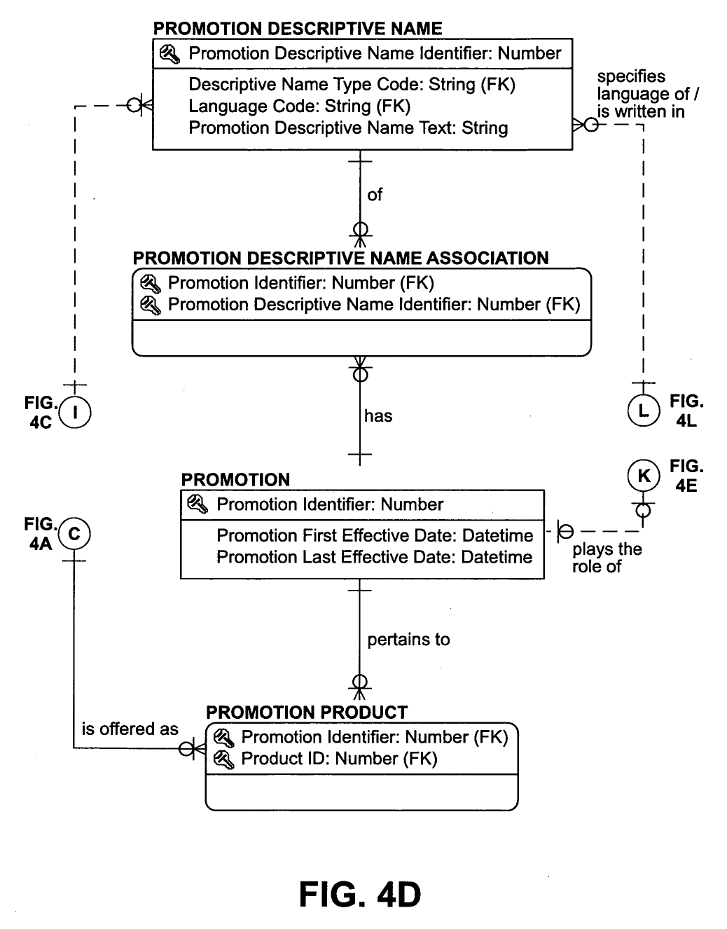

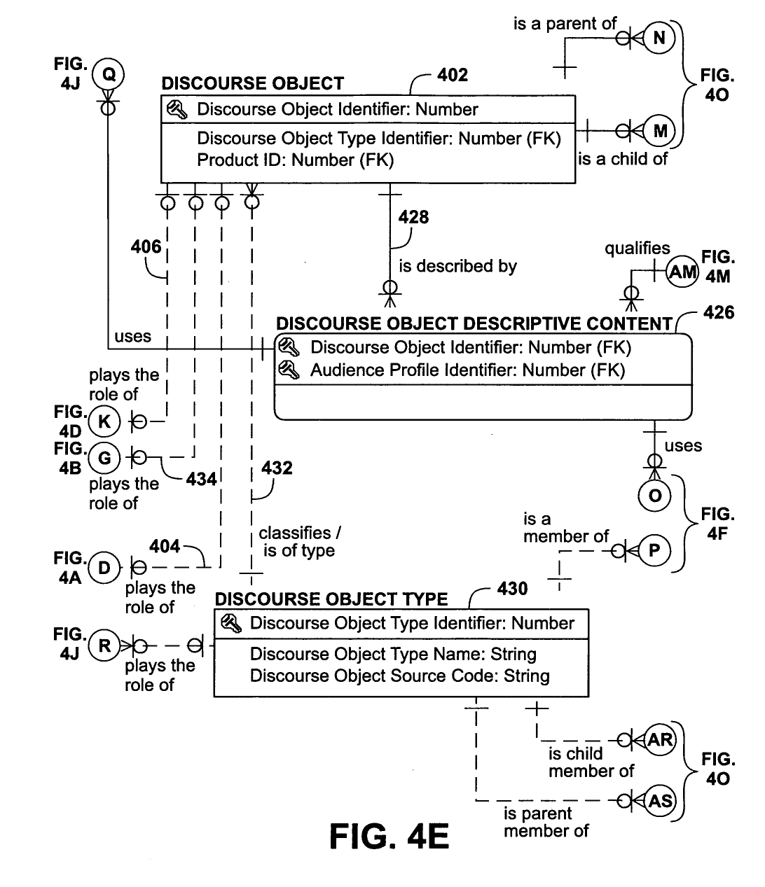

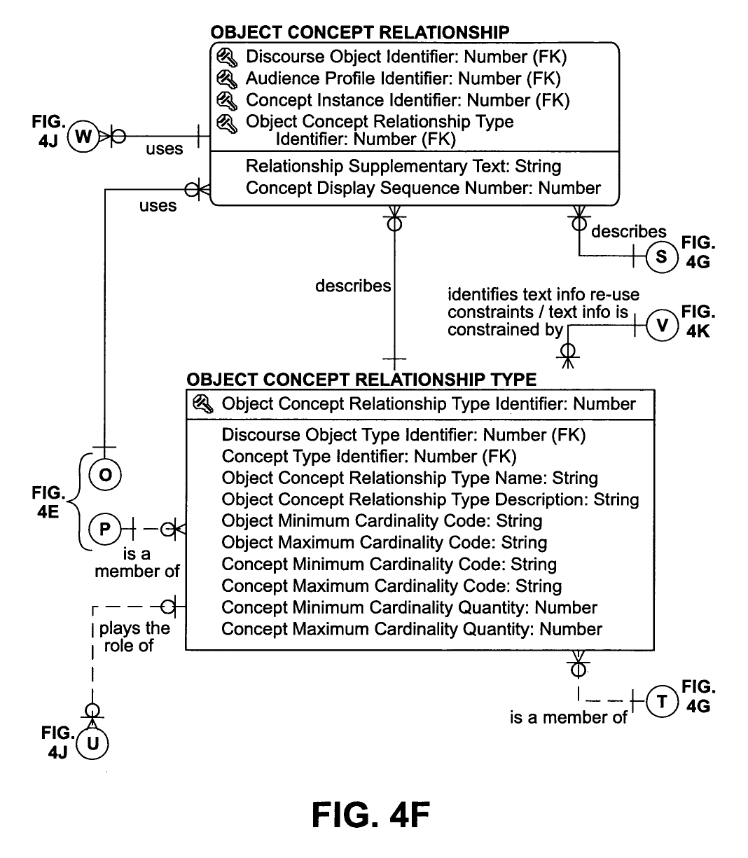

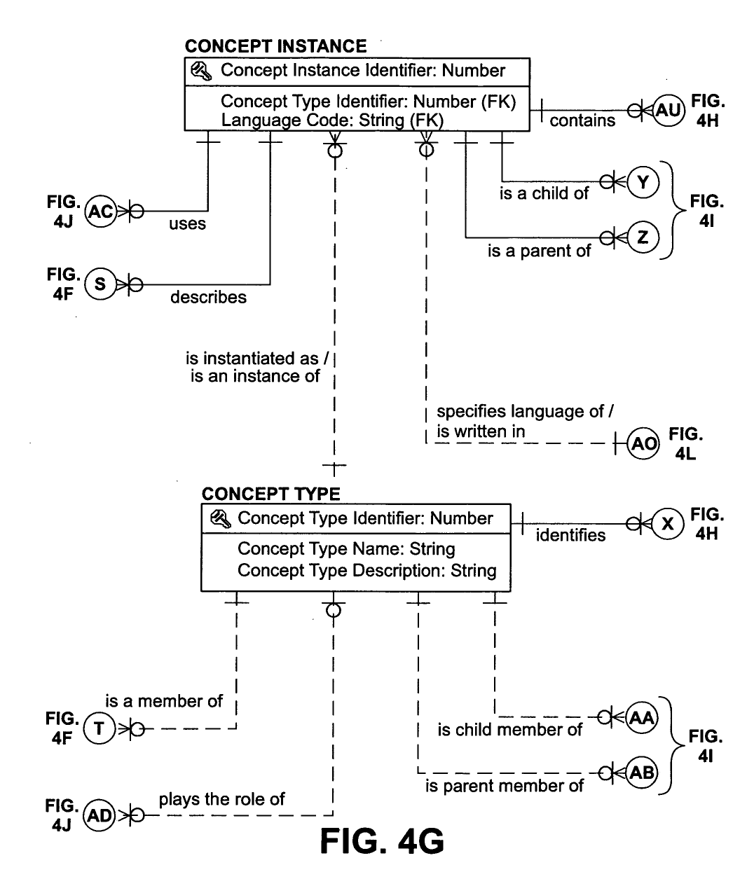

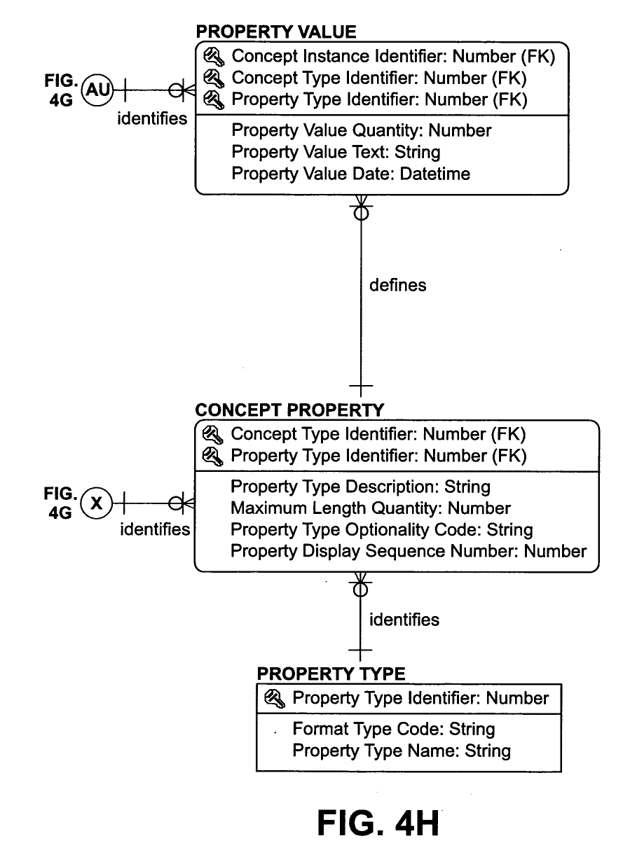

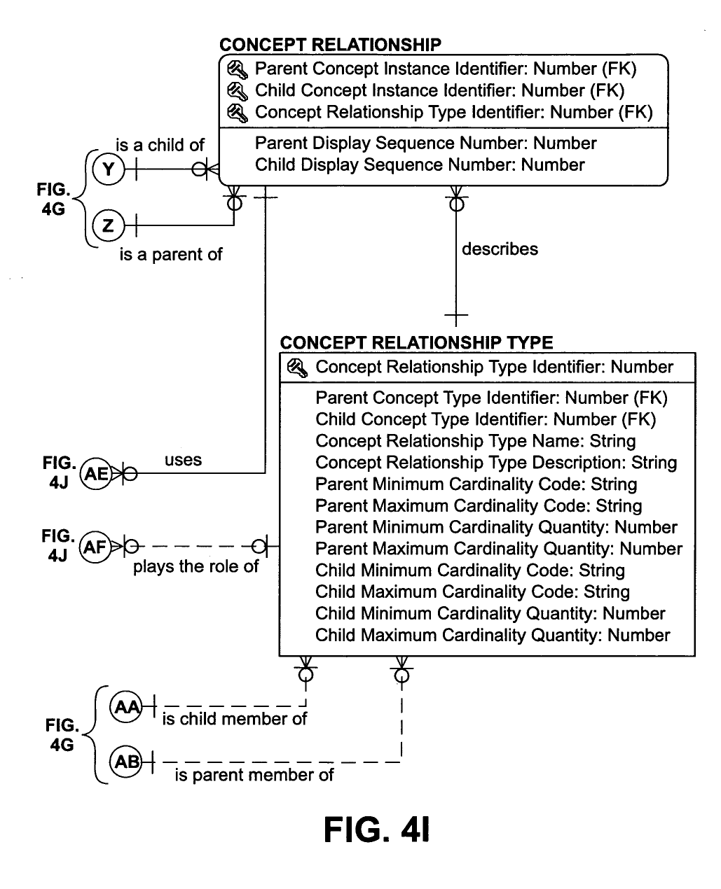

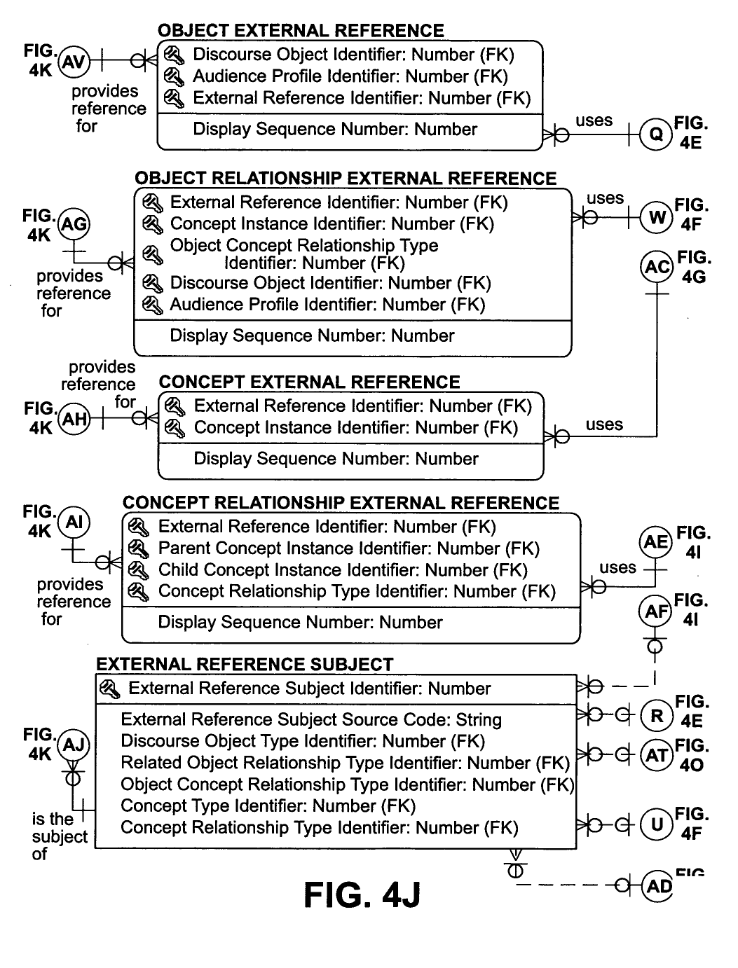

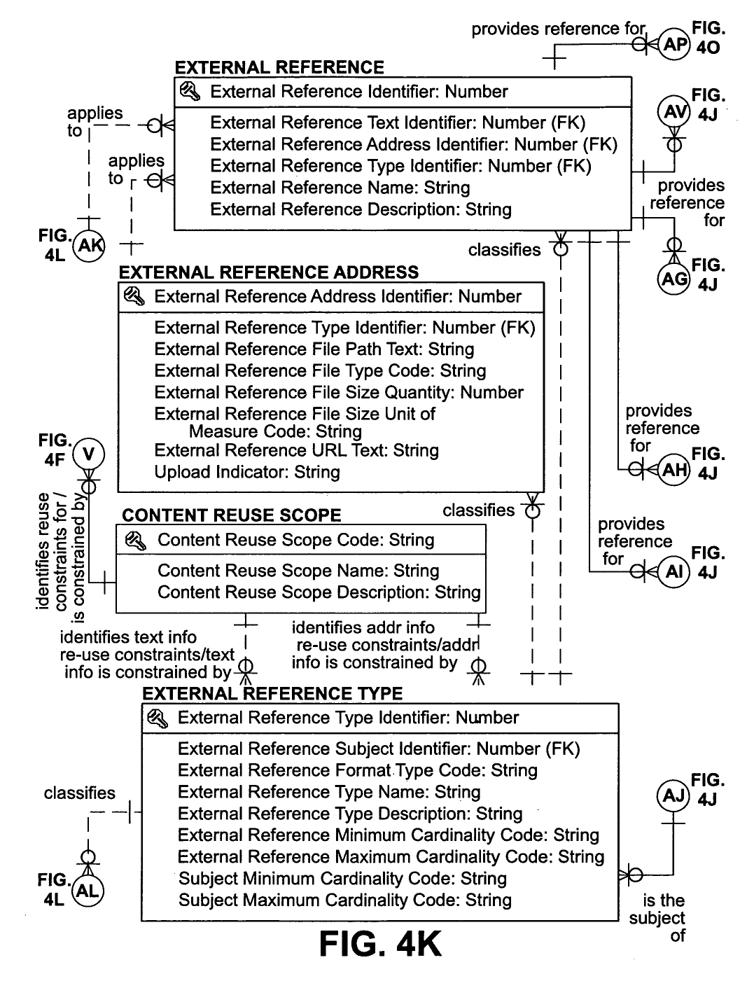

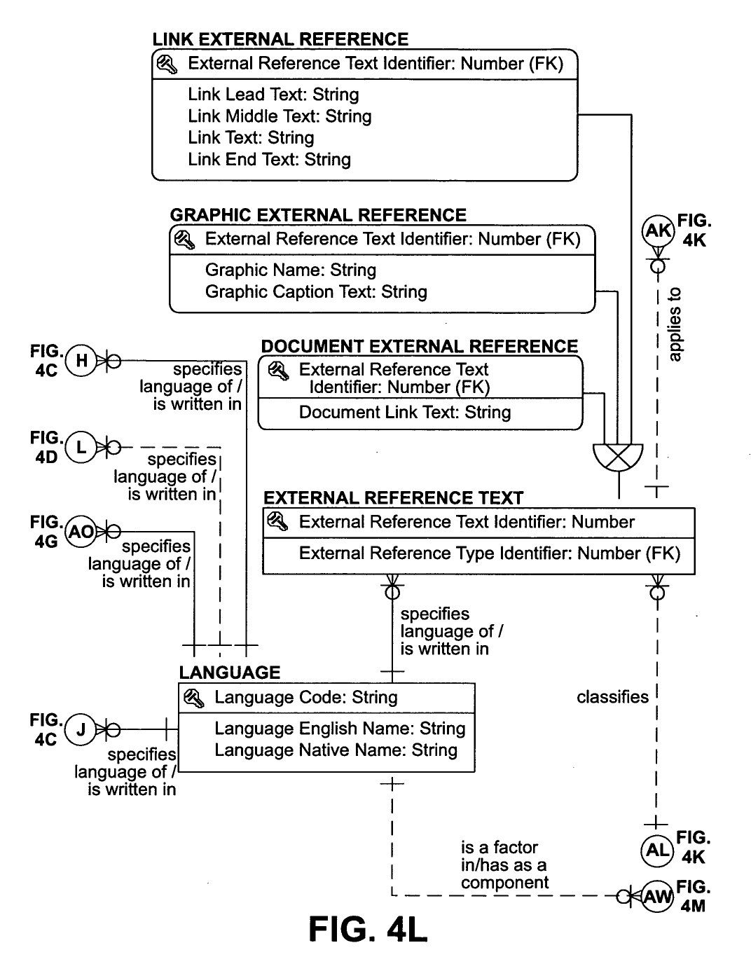

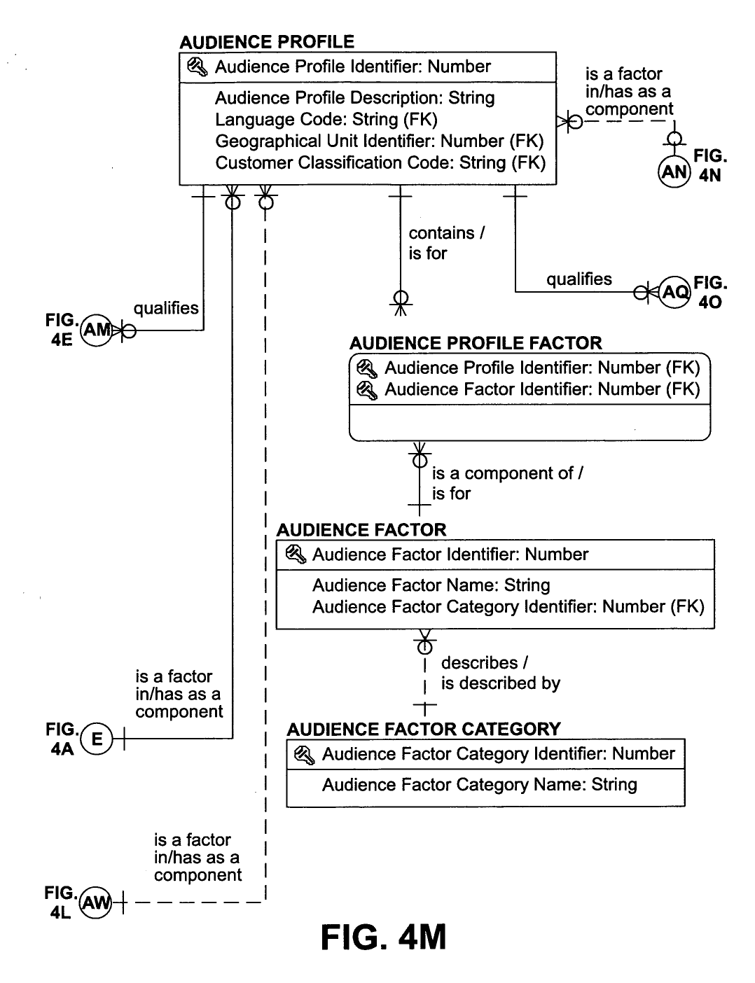

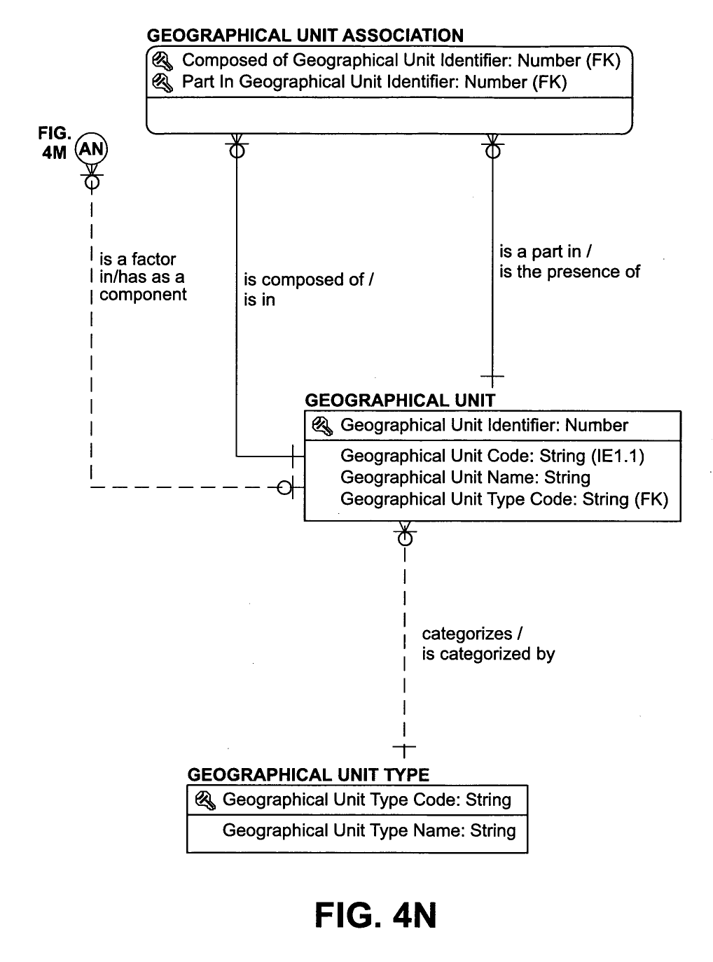

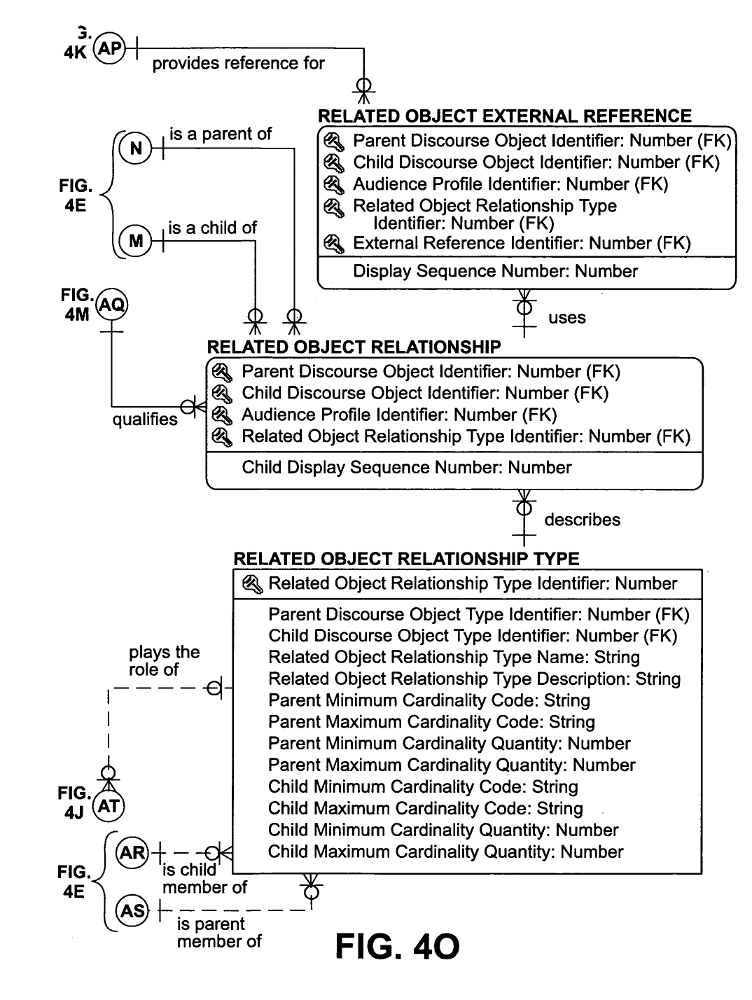

Referring to FIGS. 4A-4O a logical data model database architecture that can support the “front end” embodiment of FIG. 3 is illustrated. In the upper left corner a site map 400 is provided that describes a relationship between FIGS. 4A through 4O. An exemplary embodiment of a database “schema” or a collection of metadata (data about data) that describes relationships between tables and fields in a database for a “liquid content” data model is provided. Liquid content may refer to data organized and formatted such that it is easily re-useable in different contexts and in many different formats.

The exemplary database schema can be described as a “layout” of the database or a blueprint that outlines the way data and metadata can be organized into tables and fields that are linked to other tables and fields or entries in the tables and fields. The schema illustrated provides relationships between each table (dashed lines connecting tables), the relationships between fields and tables and defines data parameters such as numbers, strings, date time etc.

Referring first to FIG. 4E, discourse object table 402 provides a central table for the database. As stated above, a discourse object can be anything to be described. Discourse object table 402 is utilized as a starting point, because this is often what the front-end application would use as starting point for either entering content or retrieving content.

Discourse object descriptive content table 426 and discourse object type table 430 are linked to discourse object table 402 to further classify support for discourse objects. In the example, the discourse object table 402 links to promotion table 410 on page 4D via link 406, to product grouping table 412 on page 4B via link 434, to product table 408 on page 4 A via link 404, to discourse object type table 430 via link 432, and to discourse object descriptive content table 426 via link 428.

Tables that support the discourse object tables can provide information or data that supports a discourse objects found in discourse object table 402. Many other relationships between tables are illustrated as links in FIGS. 4A-4O. Thus, most tables provide support for the discourse object either directly of indirectly. The database schema can be thought of as an “Entry Relationship Diagram” that models where and how data is placed when it is entered into a liquid content database based upon a classified “meaning.”

Definitions of the fields in the tables can be stored in a data dictionary. Exemplary data dictionaries are provided in Appendices A and B. The logical data model is structure such that it could be implemented utilizing nearly any commercially available database software product such as Oracle® and SQL Server®.

Referring to FIG. 4A, product table 408, product type table 420, and customer classification table 422, provide support for a “product” that could be a type of discourse object stored in the discourse object table 402. Product table 408 may store names of product names while product type table 420 may store different classifications or types of products. Customer classifications table 422 may store types of customers interested in, or associated with the products listed in product table 408. Some tables may store a single word that acts as a rhetorical building block

Product table 408 and promotion table 410 are examples of user defined/definable business data objects. Thus, product table 404 and promotion table 410 are tables that may be created or named by the user, while other tables such as the discourse object table 402 is considered a primary table which could be utilized in other, possible non-business applications. The exemplary tables 402 408 412 420 422 426 and 430 discussed above can store atomic level rhetorical units such as concepts, words, sentences, and variables for insertion into the sentences. The links between tables can be activated responsive to user input regarding content management and other database rules.

Hence, link 428 in FIG. 4A illustrates the link between discourse object table 402 and descriptive content table 426. Thus, if a user wants to describe a discourse object, the link 428 would be utilized to locate the supporting materials. Likewise, “properties” that can provide facts or opinions about a discourse object be combined with a discourse object responsive to a link. As can be appreciated by referring to sheet map 400, a small portion of the tables and links of the entire database schema have been described. For additional definitions regarding the table nomenclature, Appendices A and B can be consulted.

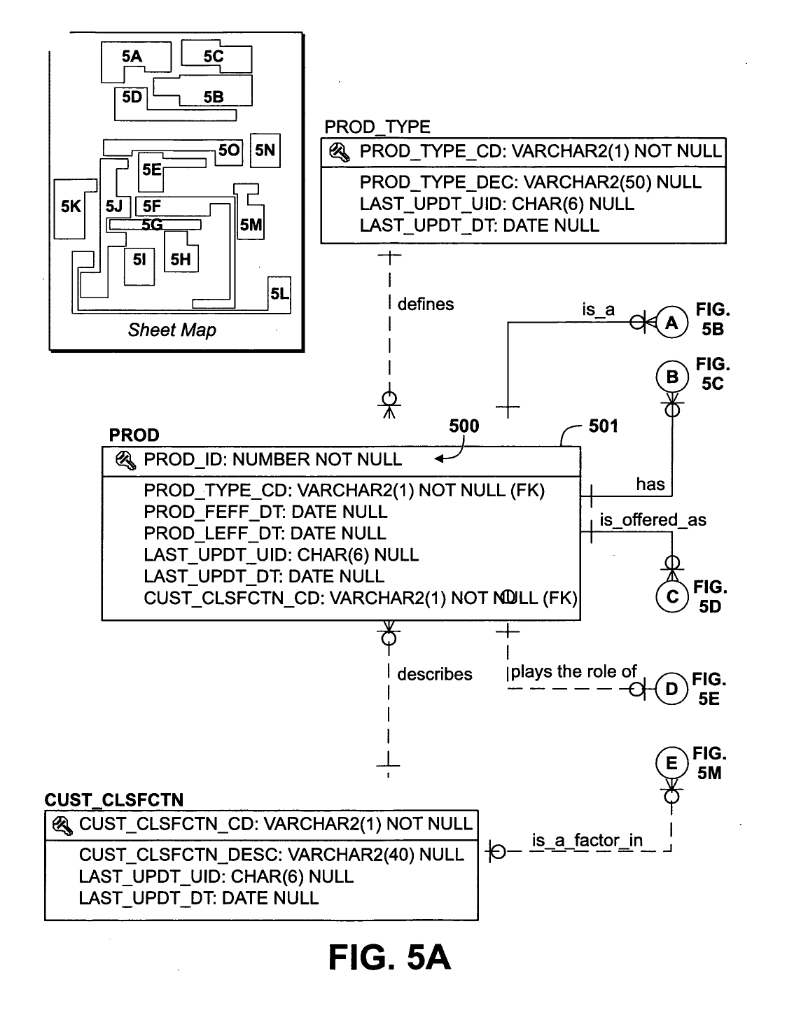

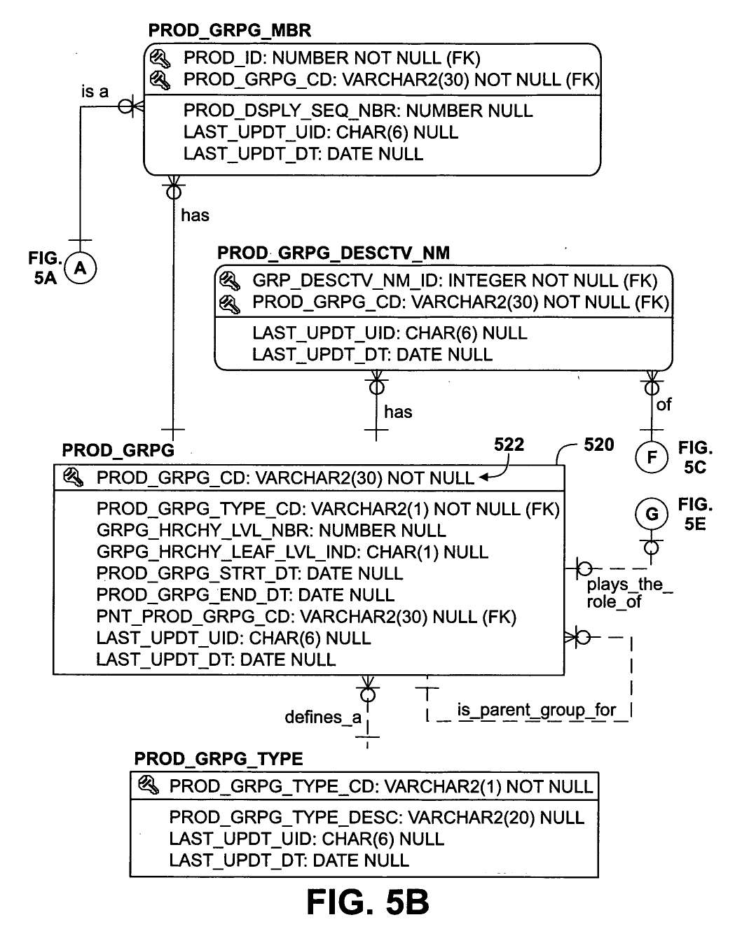

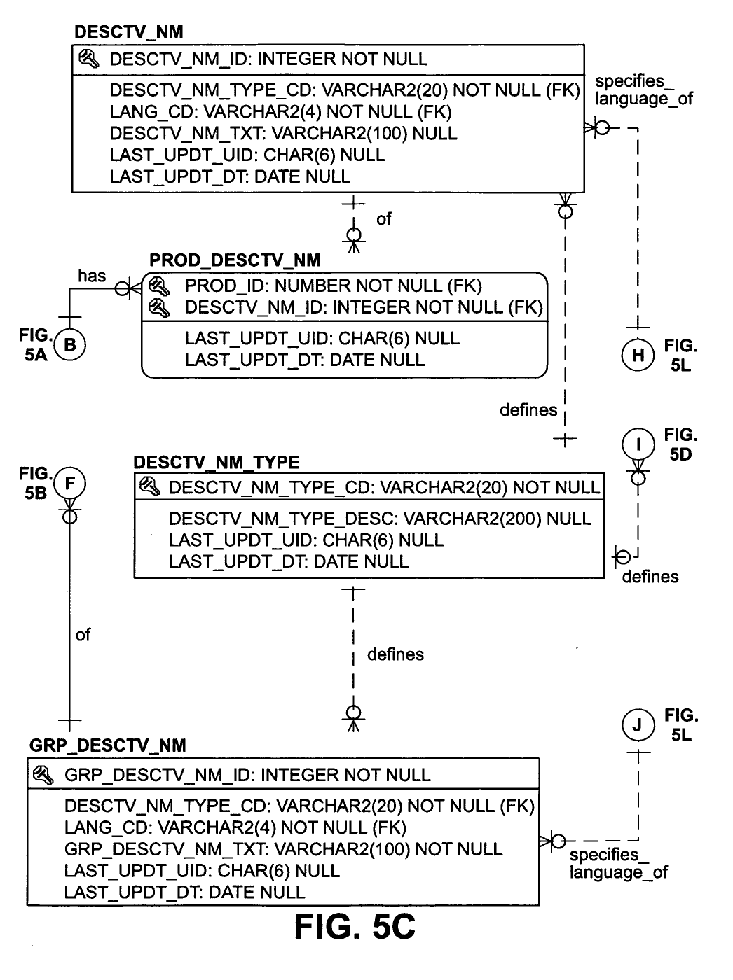

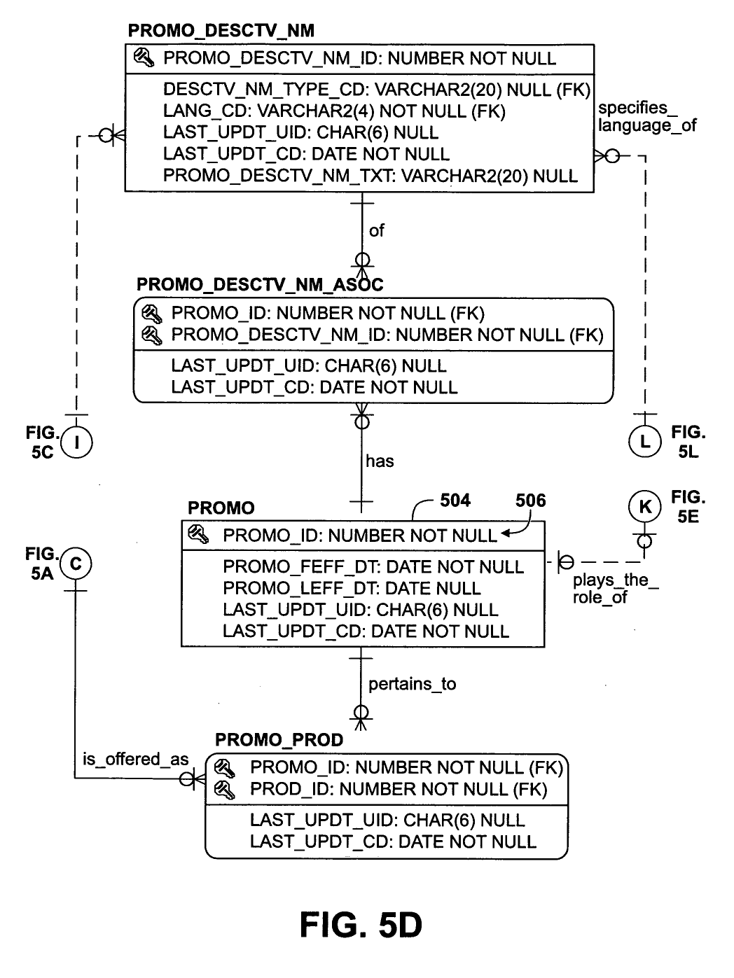

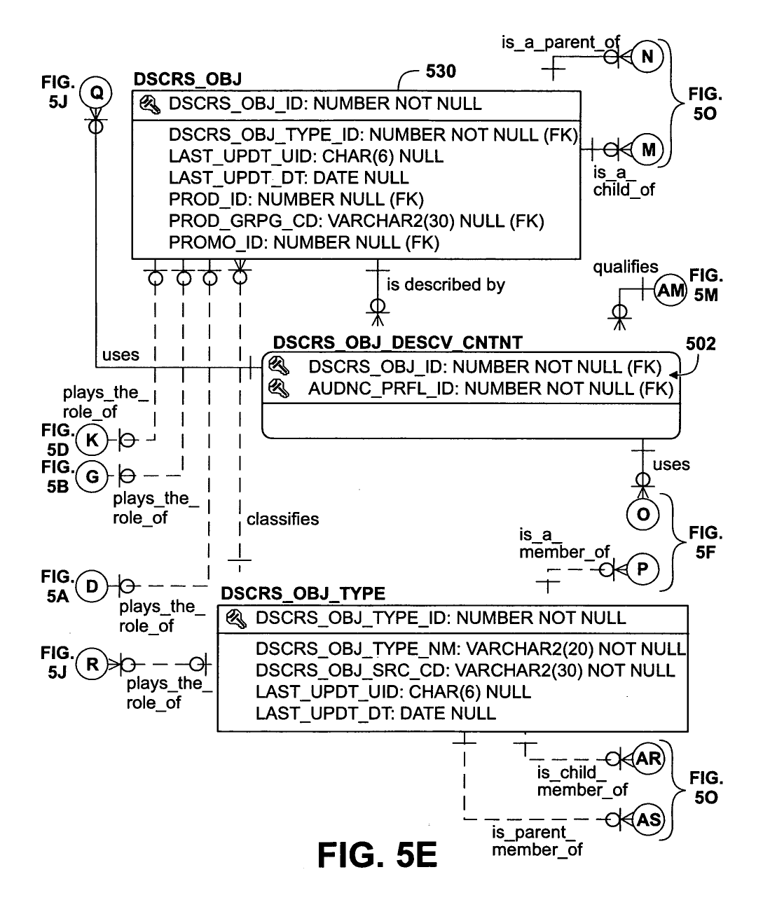

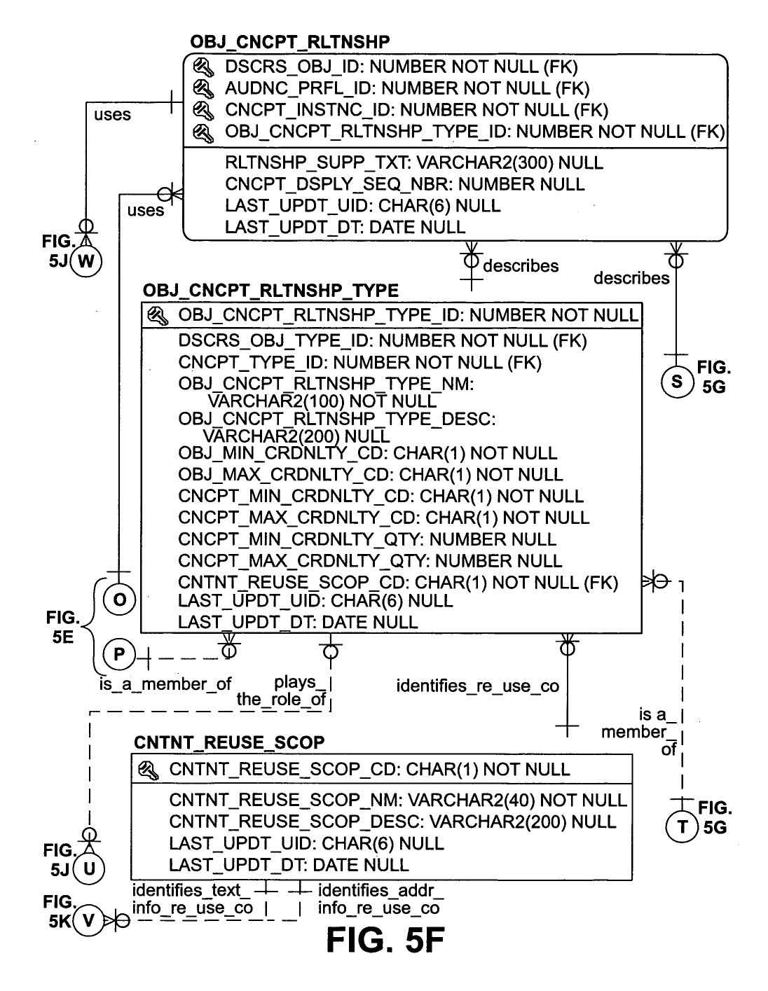

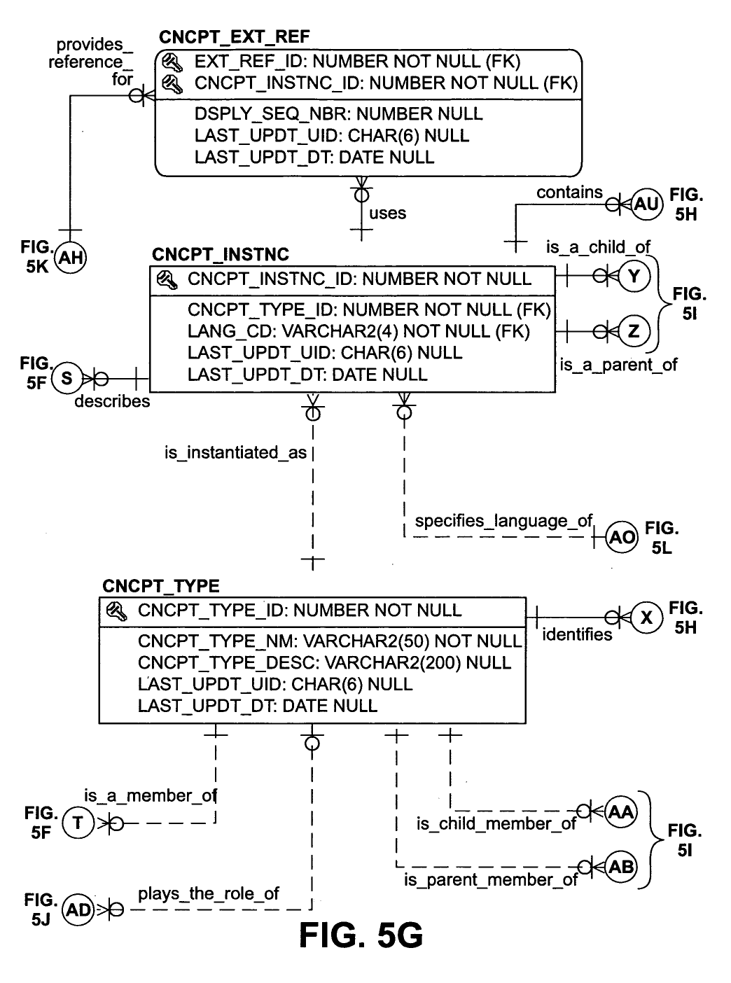

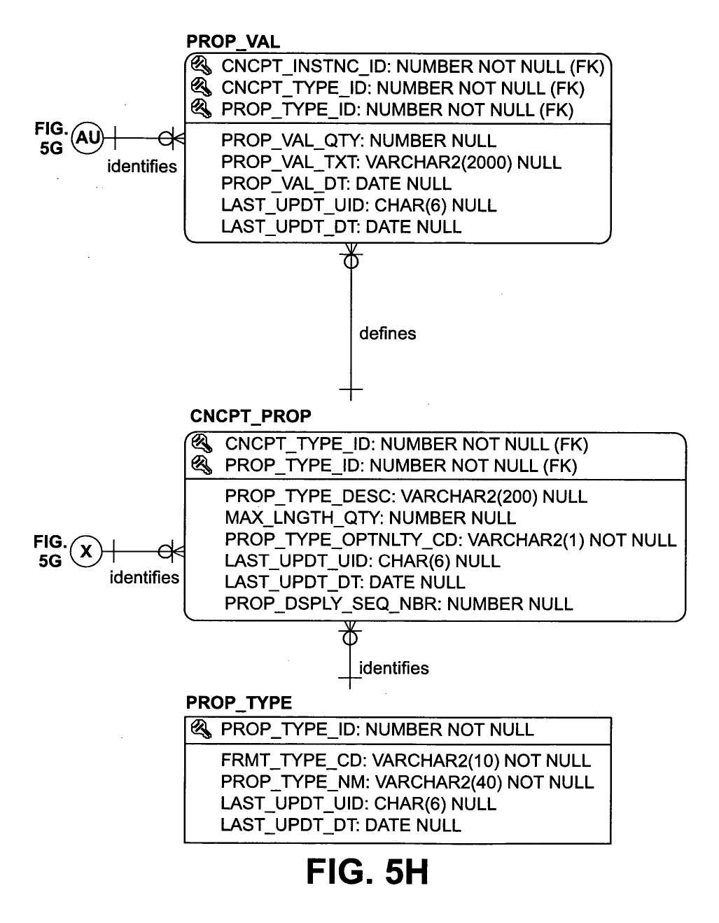

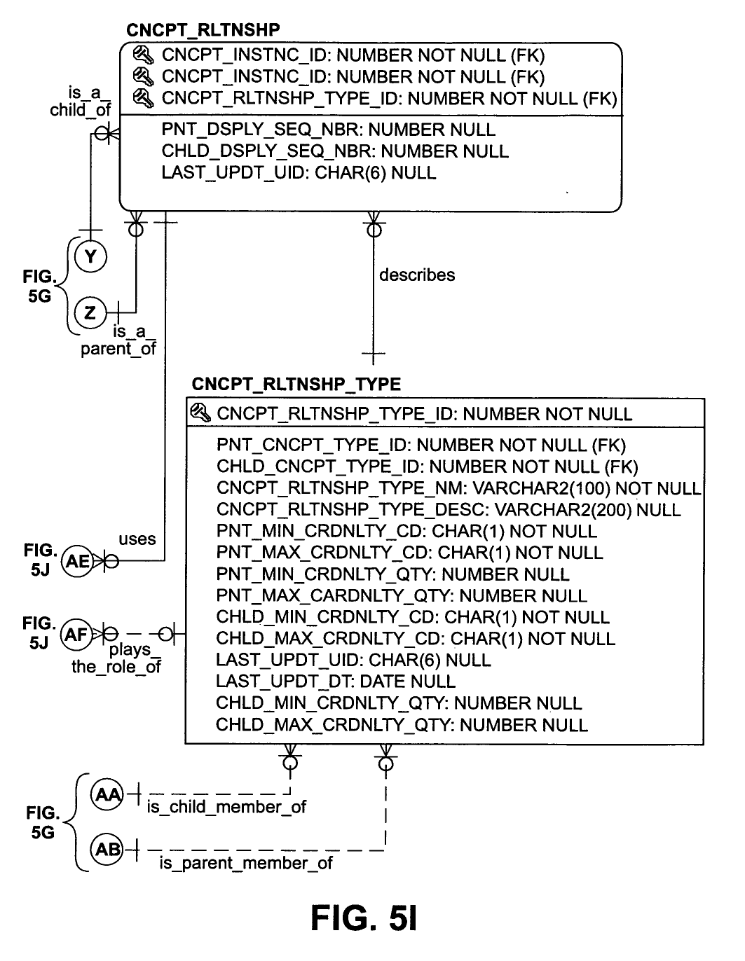

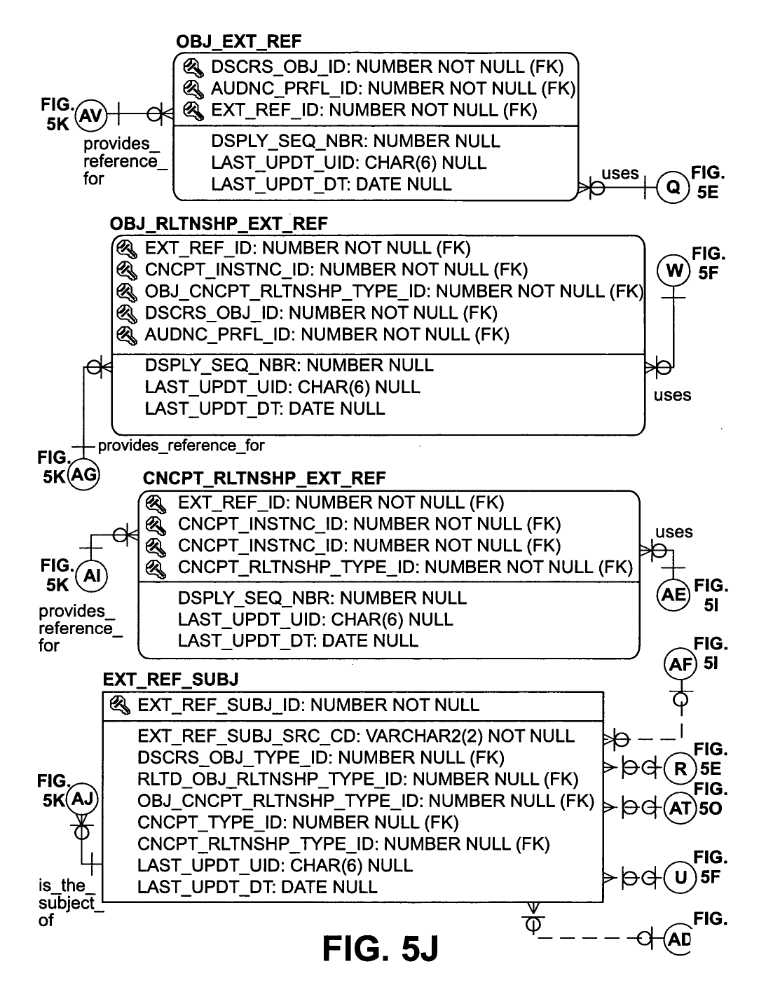

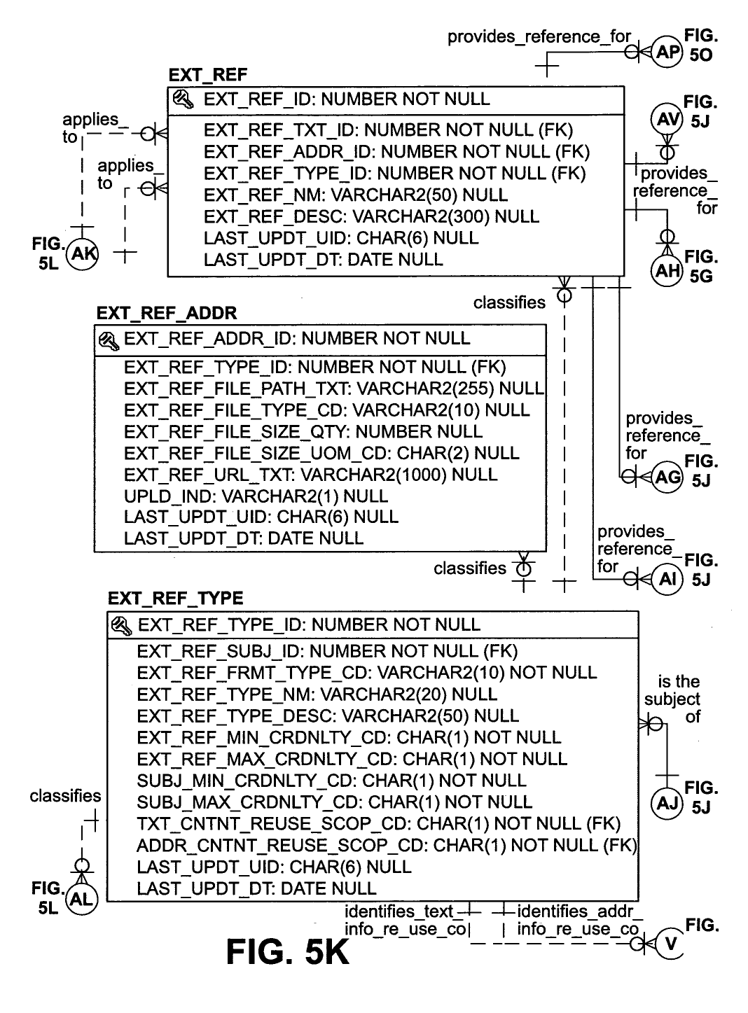

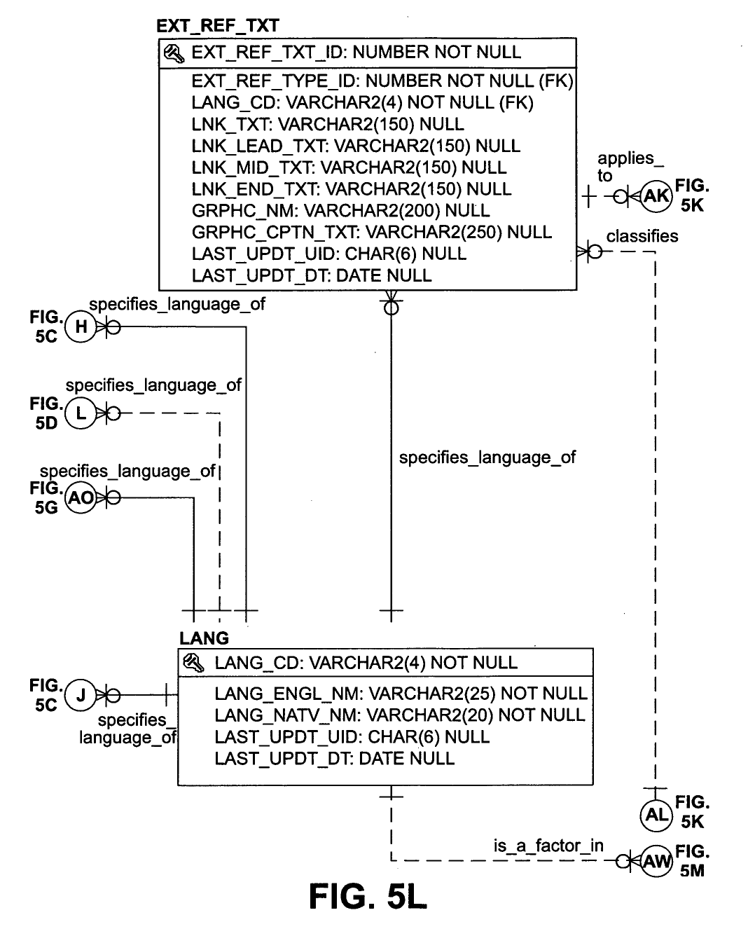

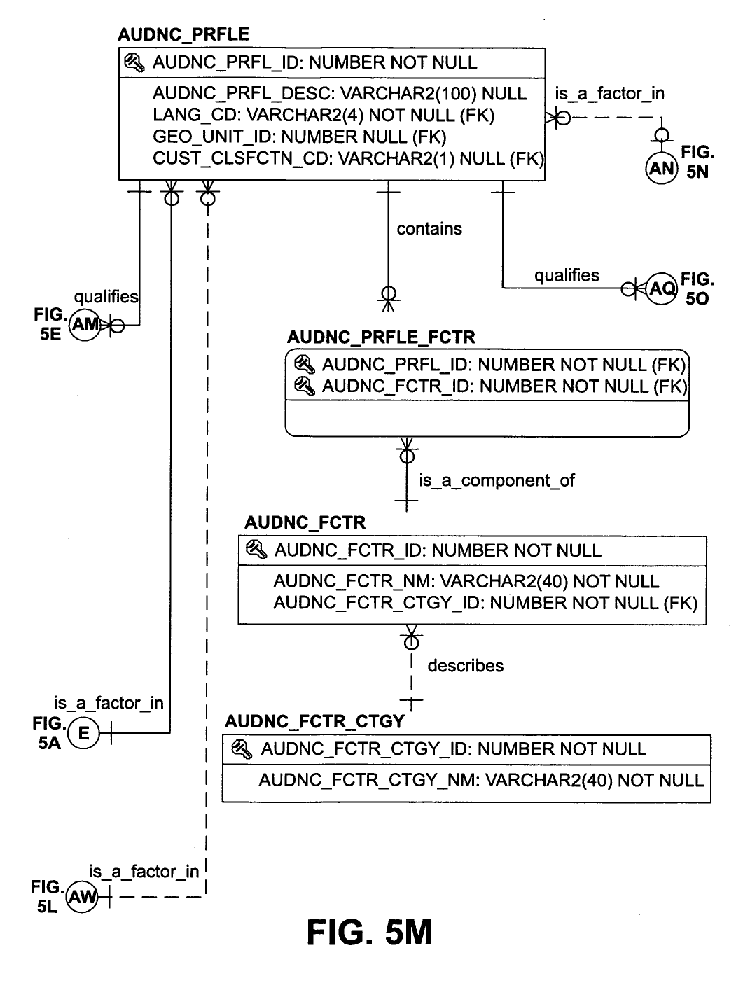

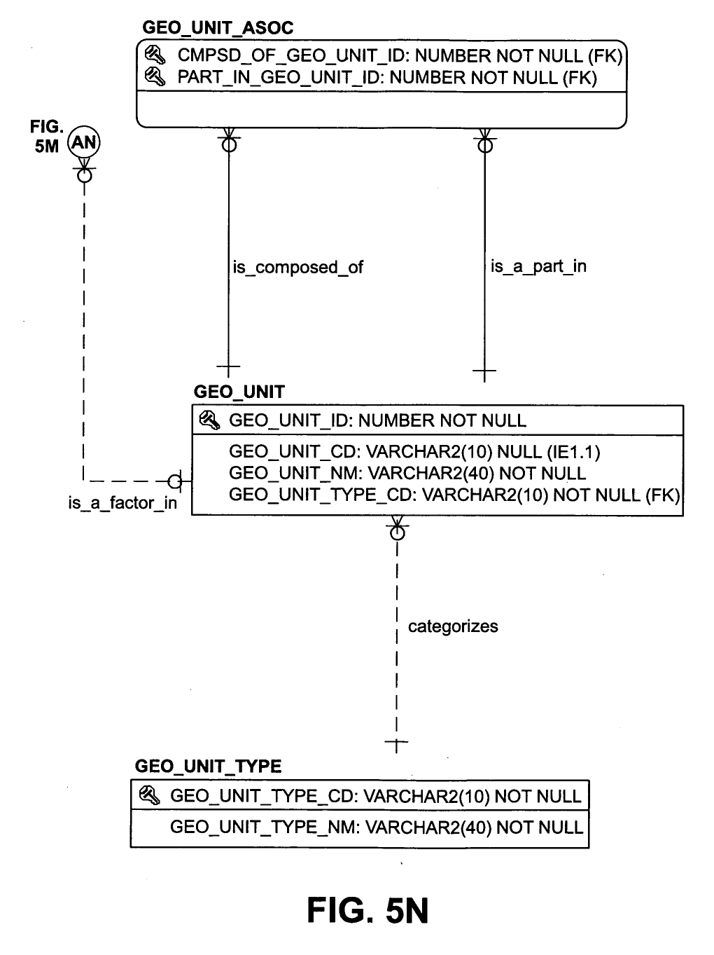

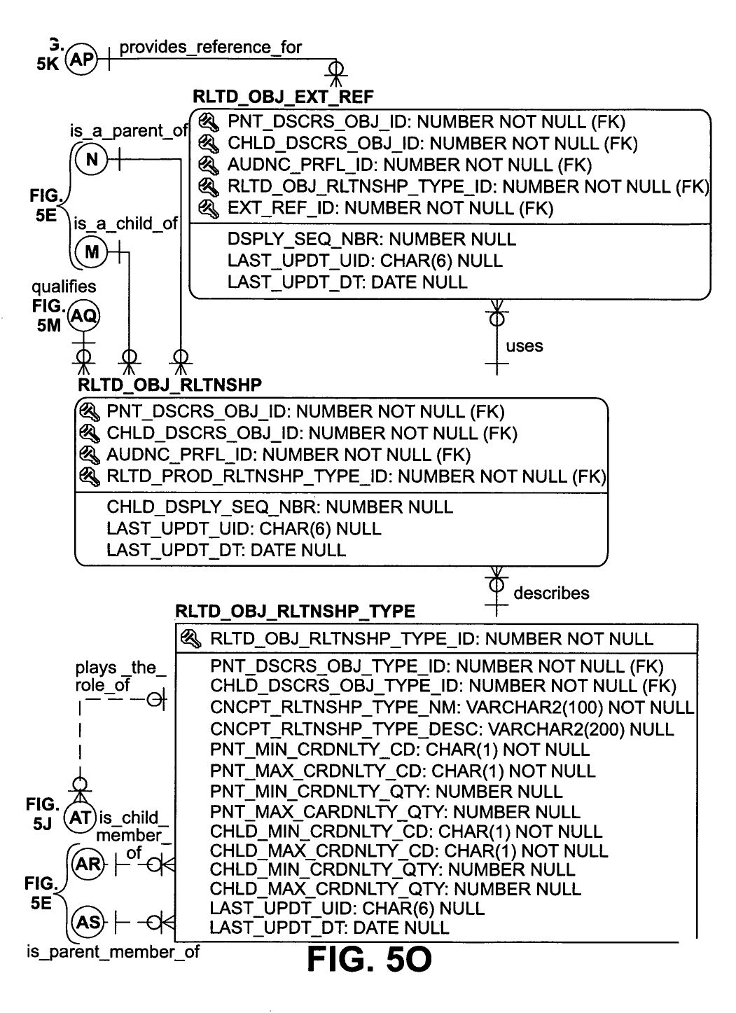

FIGS. 5A through 5O represents a physical data model of the logical data model database of FIGS. 4A-4O. A physical model is an embodiment that conforms to an off-the-shelf data processing product or application. In the exemplary configuration the physical liquid content model is implemented in a SQL Server® platform sold by Microsoft®. The illustrated implementation is an example of a specific database schema or architecture for a business application where content regarding a product can be created by a user. However, the specific embodiment described is not to be construed to limit the scope of the present disclosure as “product” is but one example.

Referring to FIG. 5A, PROD_ID 500 illustrates a file in the PROD table 501 that is provided in a format or language recognizable by a SQL Server® product. In this physical model (product specific model) variables such as PROD_ID 500 is database specific nomenclature for a product identifier and PROD table 501 represents a table for storing data associate with products. Referring to FIG. 5D, PROMO table 504 and PROMO_ID 506 can be utilized to store promotional data for the product and likewise in FIG. 5B PROD_GRPE_table 520 and PROD_GRPG_TYPE_CD 506 are tables for grouping like products, for example different versions or model numbers. As discussed above, these tables are linked together to form a relational database.

Referring to FIG. 5E, the DISCRS_OBJ table 530 is again featured as a central table because most entries into the database are linked either directly or indirectly to entries in the DISCRS_OBJ table 530. The DISCRS_OBJ table 530 is linked to DSCRS_OBJ_ID 502 where identification number associated with a specific discourse object can be stored.

As is illustrated in FIGS. 5A-5O, based on the user selections many tables can be created and linked together. Utilizing data entries and the links or relationships, quality content can be generated with minimal user input. Referring again to Appendices A and B, the table names of FIGS. 5A-5O can be located in the “physical table name” column to provide additional descriptions for the tables parameters.

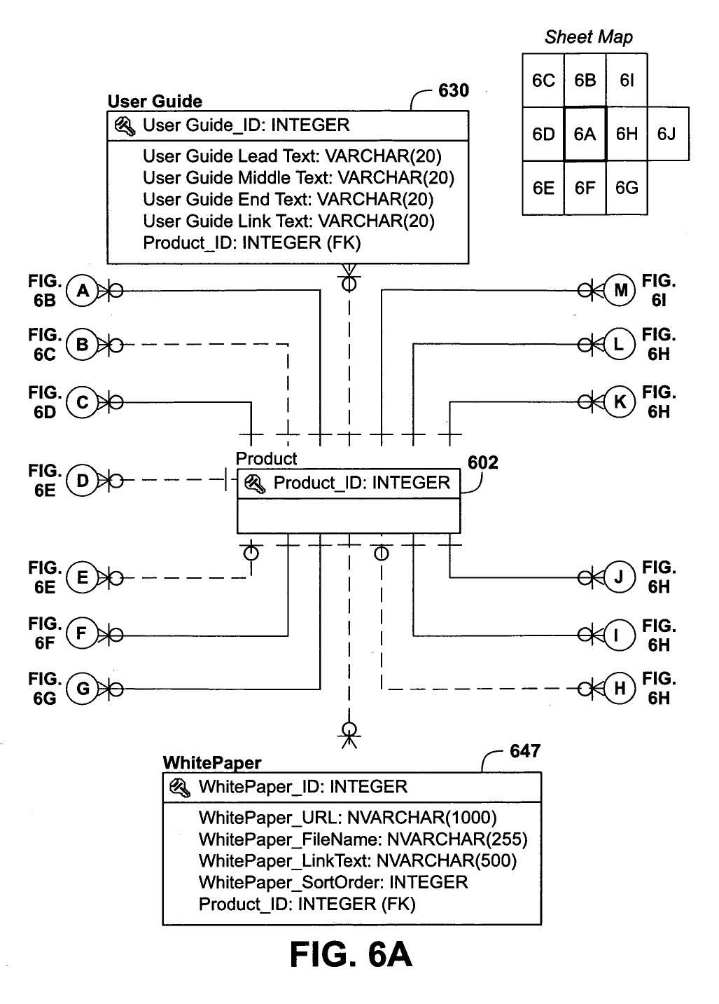

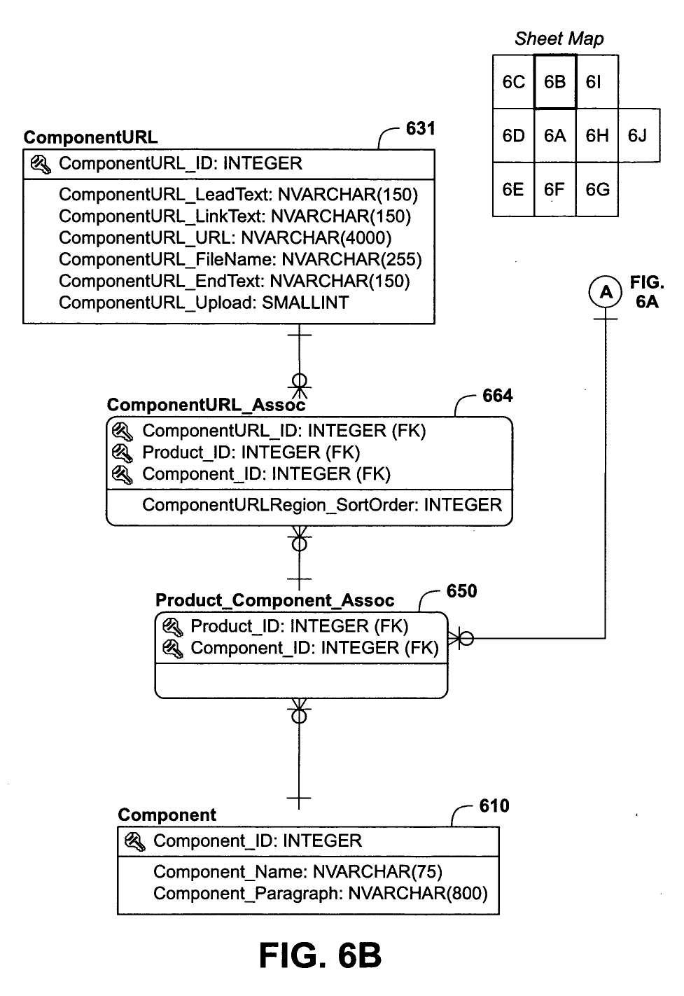

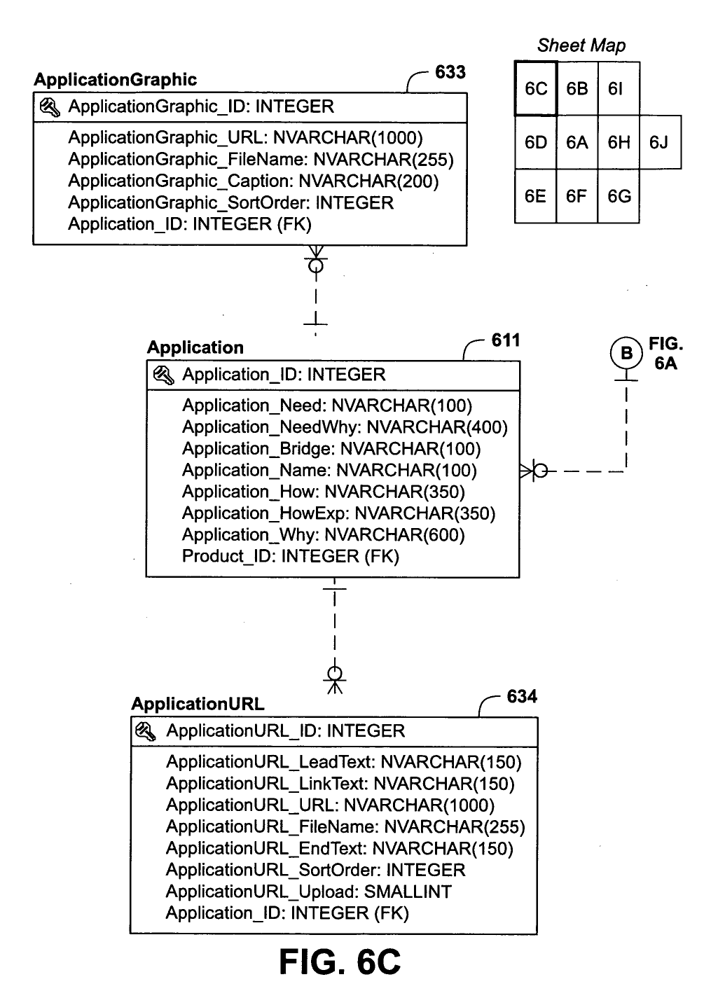

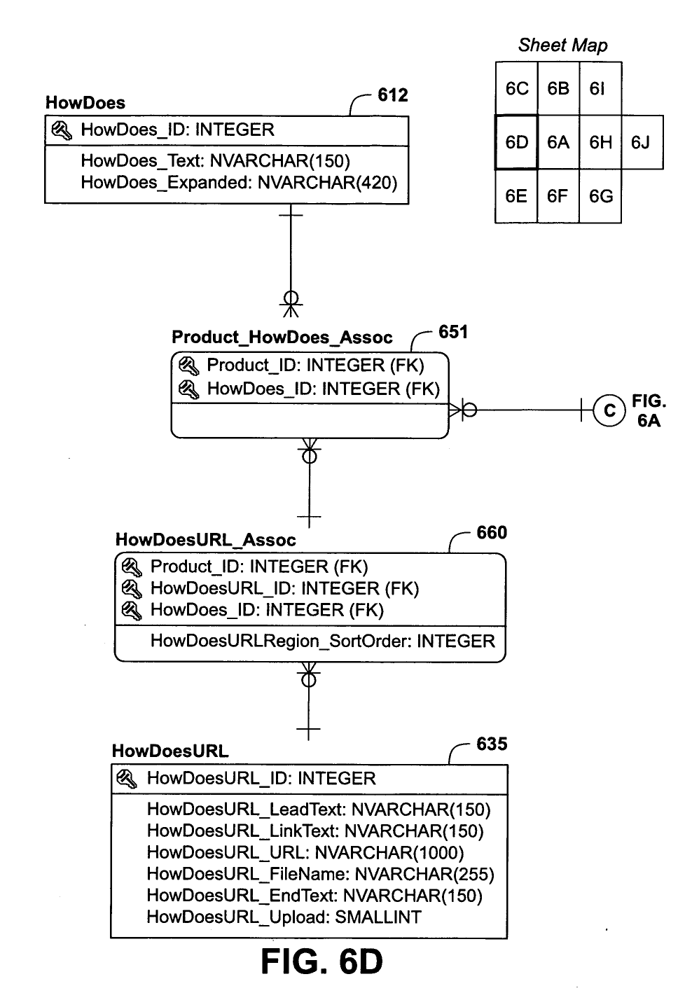

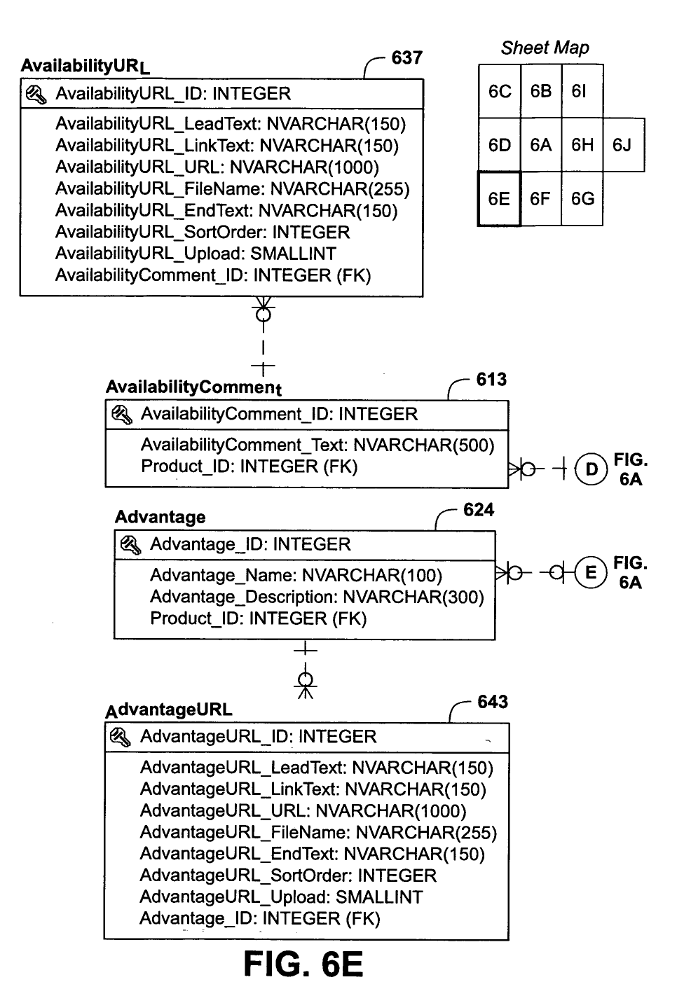

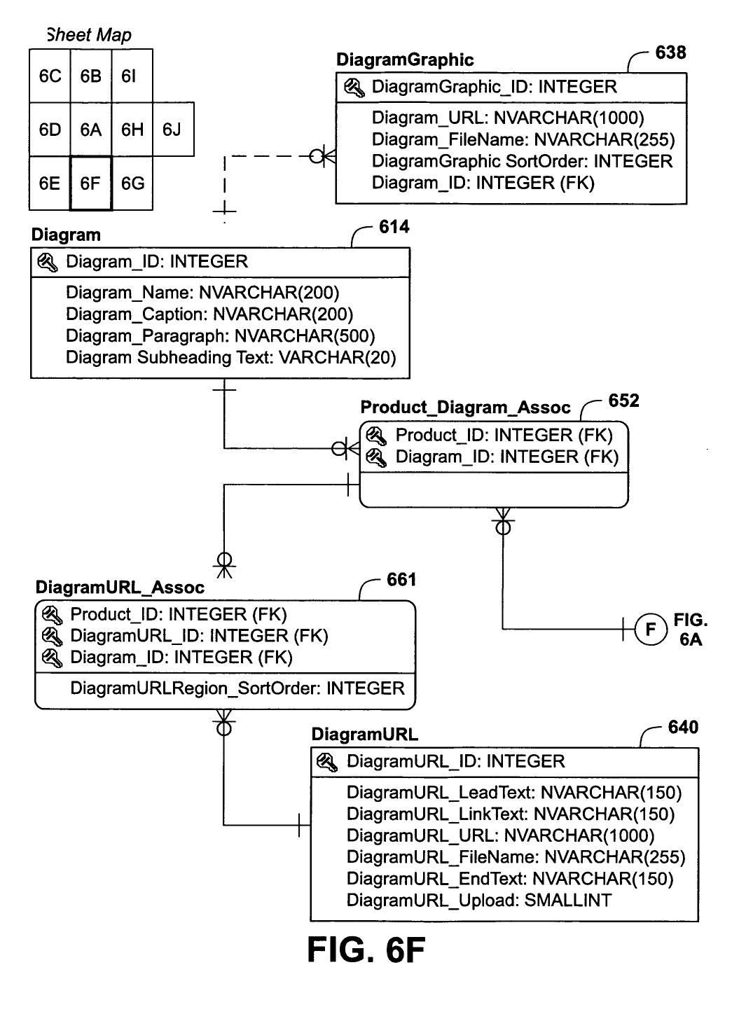

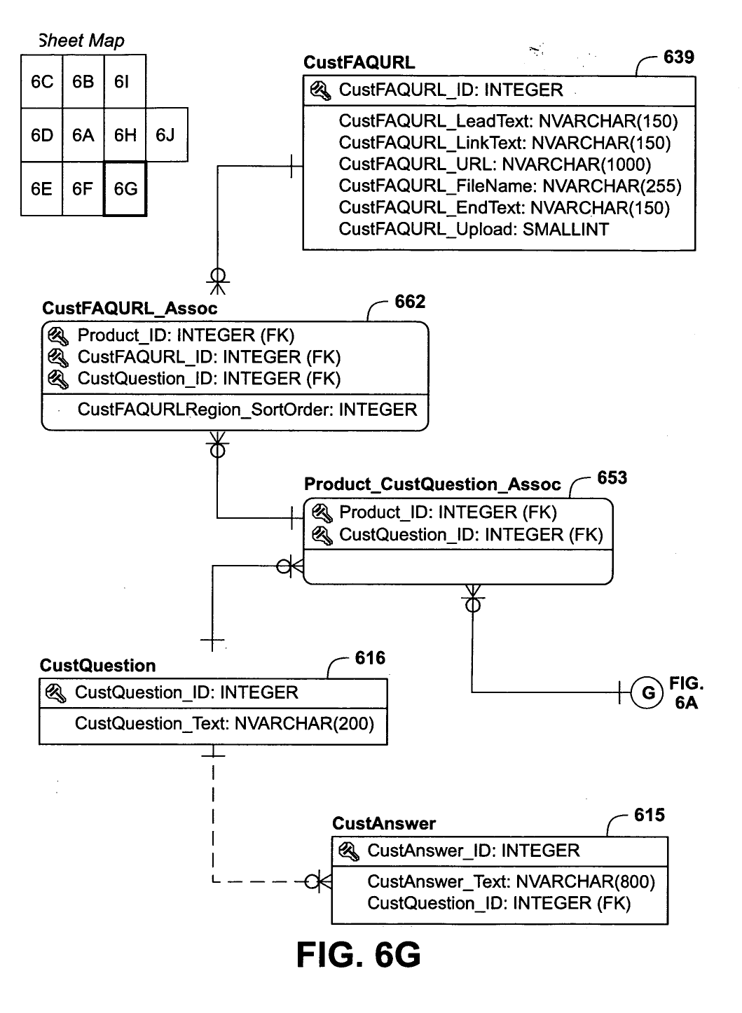

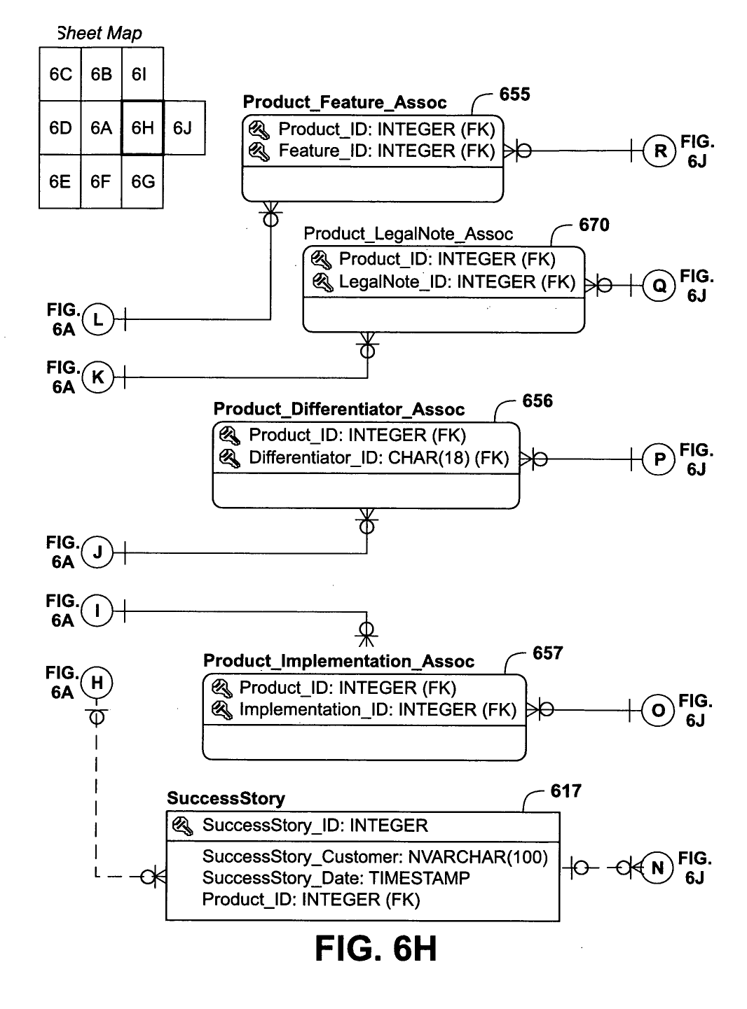

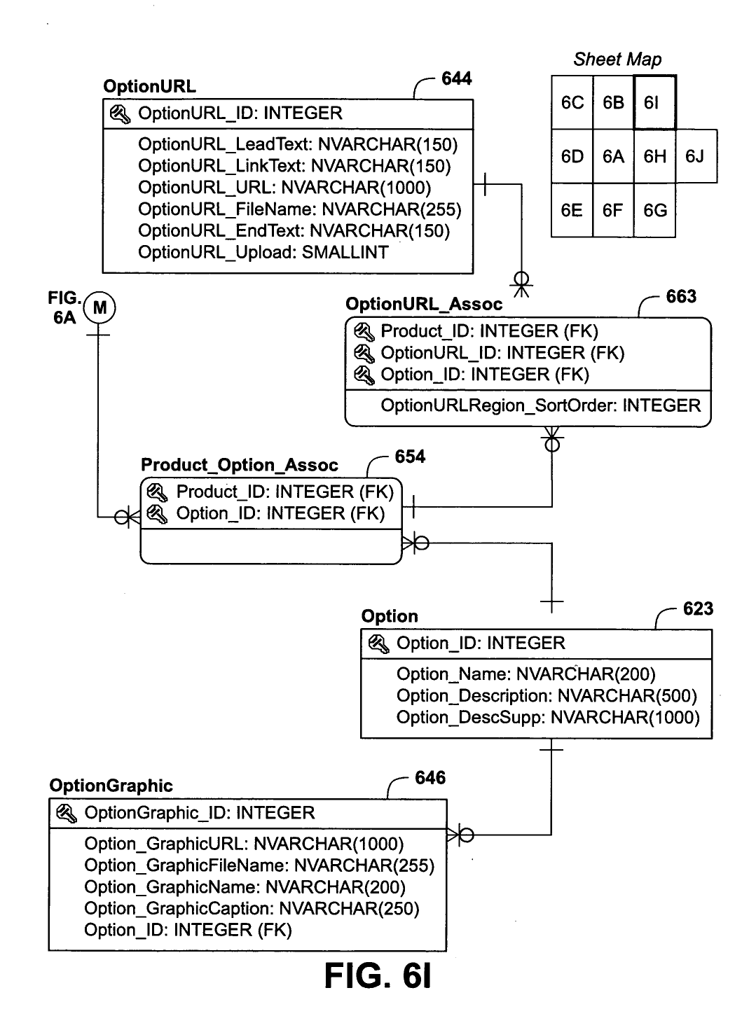

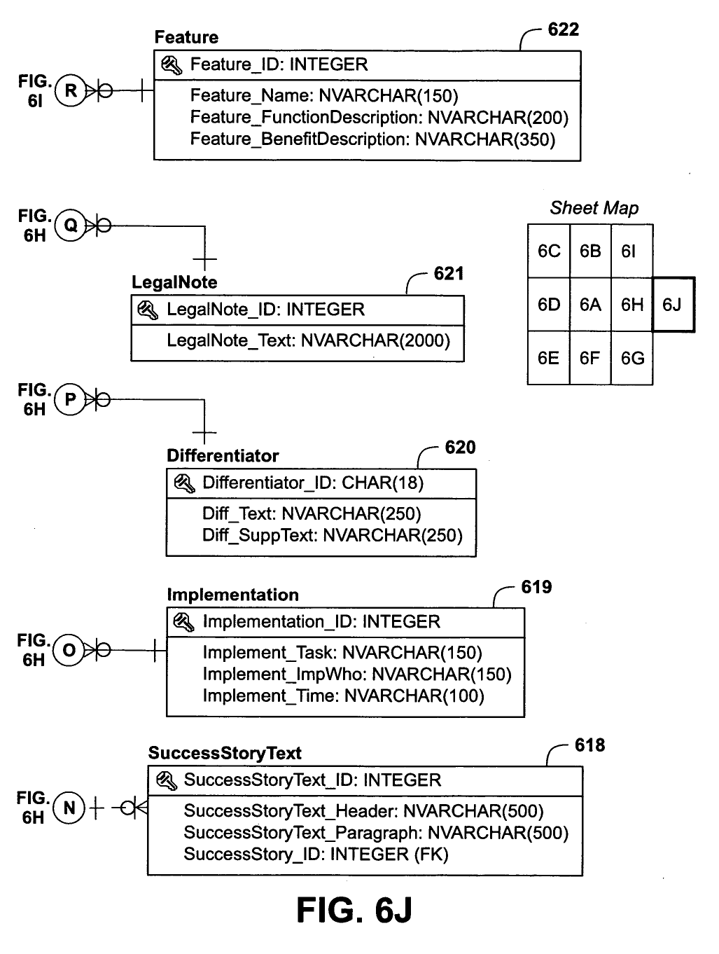

FIGS. 6A-6J provide an explicit model that utilizes a Product table 602 (FIG. 6A) as the central table, thus the title explicit model. FIGS. 4A-4O and 5A-5M utilize a discourse object table as the central table and thus are referred to as data models. The explicit model schema represents that a significant database structure having many tables is required to support a simple data model having a single discourse object such as “Product.” To support content for a single product there is a relatively small set of descriptive facts (e.g. properties) that need to be linked to the product in a relational database. However, even in this “simple” data model, the number of tables may become fairly large. For example, concept tables 610-624 represent different concepts that can be linked to the products stored in product table 602. External reference tables 630-647 may contain external reference types; and external reference subjects and relationship tables 660-664 may contain subjects and relationships of external references. Object concept relationship tables 650-657 may provide relationships for different objects and table 670 may provide types of concept relationships. Specifically, table 670 may provide legal content such as legal disclaimers or copyright notices selectable by a user.

In accordance with one implementation of the explicit model, individual discourse objects, concepts, and external references, may be represented as individual normalized tables in a database. “Normalization” can be defined as the process of finding a single best home for a fact (data element) in a set of data structures based upon what it means, consistent with a set of “relational” rules. Normalization may result in either more or fewer tables, depending on which normalization rules are applied. Data in both an explicit and abstract implementation could be effectively normalized.

One difference between the explicit model and abstract model is how each model defines the meaning of a particular data element. By stepping up a level of abstraction from the explicit architecture, there may be a common meaning between similar data facts spread across many individual tables, and the system can structure the data element as a far smaller set of more abstract tables.

In the illustrated embodiment, hyperlink related facts such as Lead Text, Link Text, URL Text, End Text, and File Name might appropriately be represented as data elements that appear in many tables in an explicit architecture. However, these data elements could be abstracted as External Reference facts and represented in a single place in an abstract architecture.

Thus, each table may have columns that contain the individual descriptive facts. Discourse objects may have relationships applicable to the concepts and external reference tables. In this configuration, additional association tables (not shown) for relationships that have a cardinality of many to many could be utilized. This explicit model could explicitly represent facts as discrete data objects in the design. Further, the objects could appear on the face of a corresponding data model. For example, one fact may correspond to one data attribute column in a table.

The example in FIGS. 6A-6J illustrates that a rhetorical database for a simple discourse object or product may require 15 concept tables each having 262 columns. While no table or column definitions are provided herein, tables may represent a single conceptual real world object rather than arbitrary groupings of data elements. By examining the fields in the tables depicted, it is apparent that the same types of facts are repeated in different tables though describing different types of objects. (e.g., 7 tables contain LeadText, LinkText, EndText, URL, and File Name data components).

In one configuration, the number of tables can be minimize by minimizing the number of re-occurrences of data components while keeping the building blocks at an “atomic level.” In this configuration multiple incidence of the same and identical building blocks may not need to appear in multiple locations.

FIGS. 6A-6J discloses an explicit database configuration that provides many advantages over existing content management systems. Generally, the explicit database configuration has many identical building blocks or data elements that can exist in multiple fields of the explicit database. The explicit database architecture, while providing many benefits can be utilized to illustrate how an abstract architecture can minimize these identical database objects that occur in the explicit model.

Notwithstanding the redundancy of entries in the explicit model, the explicit database can have a single discourse object, (Product 602) relating to five (5) concept tables 611, 613, 617, 623, and 624, and 13 external references. The links or “relationships” in the database can be of various “cardinalities” or mapping formats. A cardinality may be a 1 to 1 mapping, a 1 to many mapping, and/or a many to many mapping. These mappings may also be optional or mandatory. In accordance with the present disclosure, descriptive details or properties organized by their meaning can be linked to any number of discourse objects and concepts.

It can be appreciated that in the illustrative embodiment, adding a new discourse object can be accomplished by adding a single table and the existing supporting tables can be utilized to provide content for the new discourse object. More importantly, a new data fact, such as a property can be entered into the system by adding a single column in an existing table. In one embodiment relating an existing concept or external reference to an existing discourse object or concept only requires adding a new foreign key (a 1-to-1 or 1-to-many cardinality callout) or a new association table (many to many). These changes may facilitate a change to the user interface or the front end of the application. For example, selectable buttons for the additional selections may be provided.

With a liquid content format, virtually unlimited reuse of content portions can be achieved because stored units or data elements such as properties can be assembled for publication in a number of different ways via any number of formats. For example, a description may be re-useable for different, but related products. Thus, concepts and concept properties can be shared between different discourse objects that may be related or unrelated. The system and method described herein can help maximize the re-use of data entries because it may store discrete elementary descriptive facts in a table based solely on their real world meaning.

The database schema provided can link data and support definitions of various types of alternative references such as to other documents, diagrams, graphics, or links (i.e. external references) that can be used to expand descriptive capability beyond just a particular set of written content. As stated above, although “product” is utilized as the central table in the exemplary figures the present teaching may support re-useable content for “anything of interest” or anything that can be described.

As mentioned above, the abstract model example can provide a logical data model for a schema with a higher level of abstraction than in previous figures. A higher level of abstraction is useful to create a more efficient database architecture by requiring fewer tables and less data elements (i.e. entries). Thus, in the explicit architecture adding facts correspondingly adds tables, columns and relationships wherein in an abstract architecture new facts are added as new instances to the population in existing data structures.

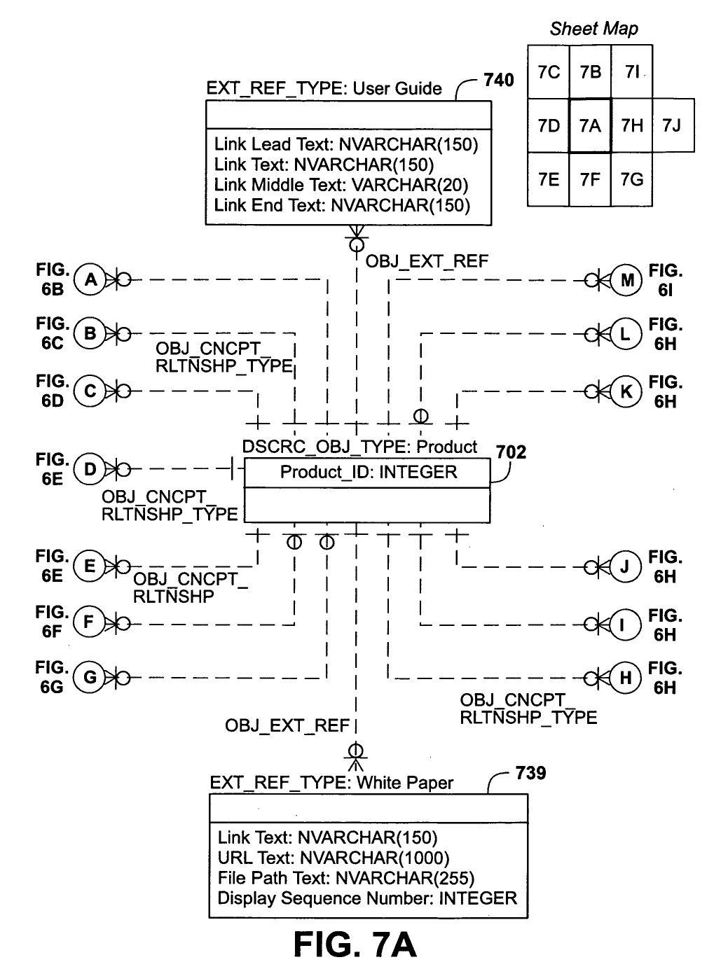

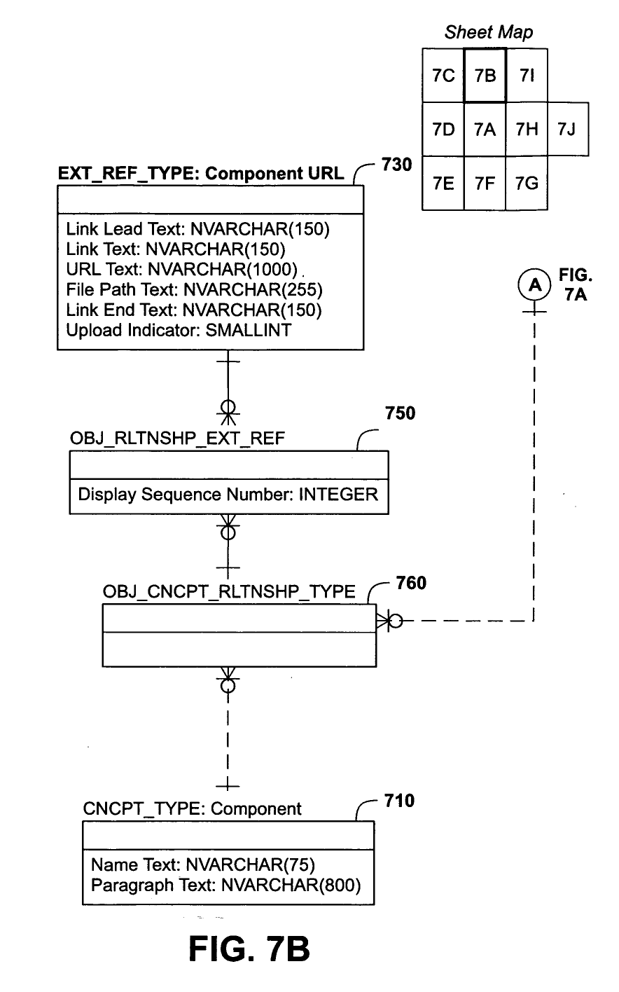

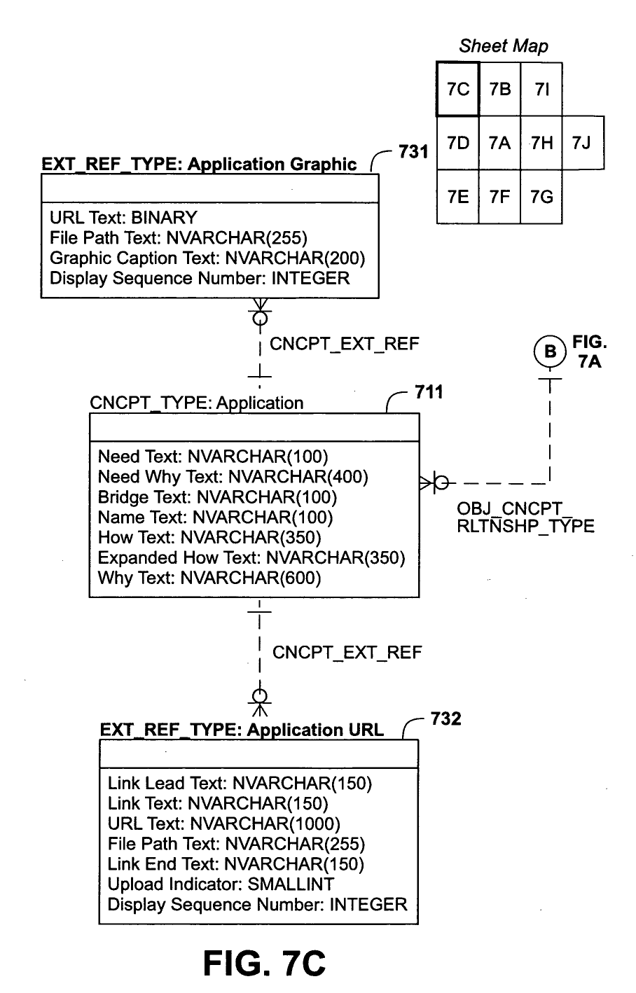

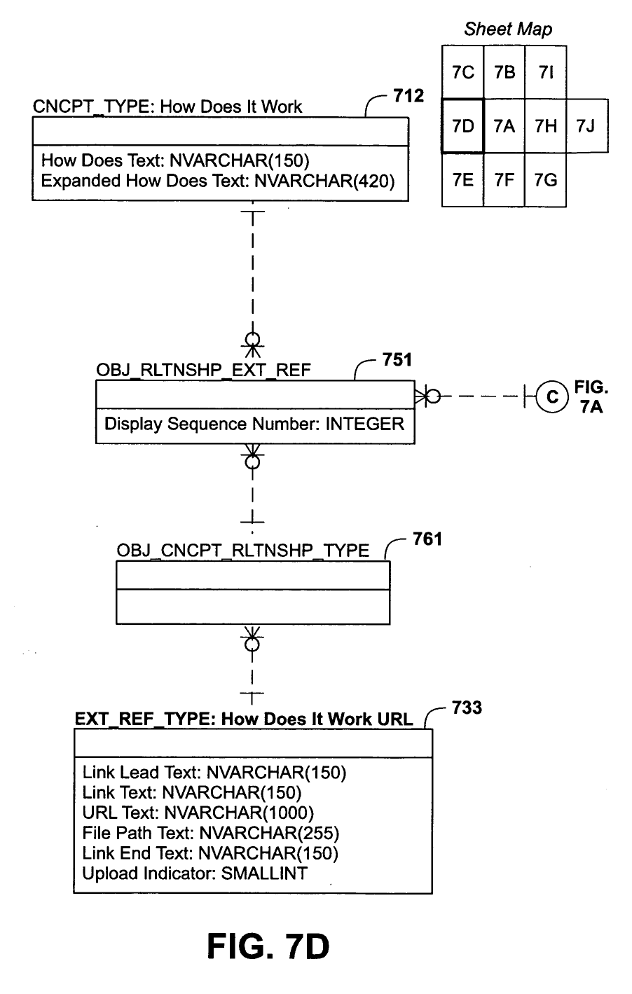

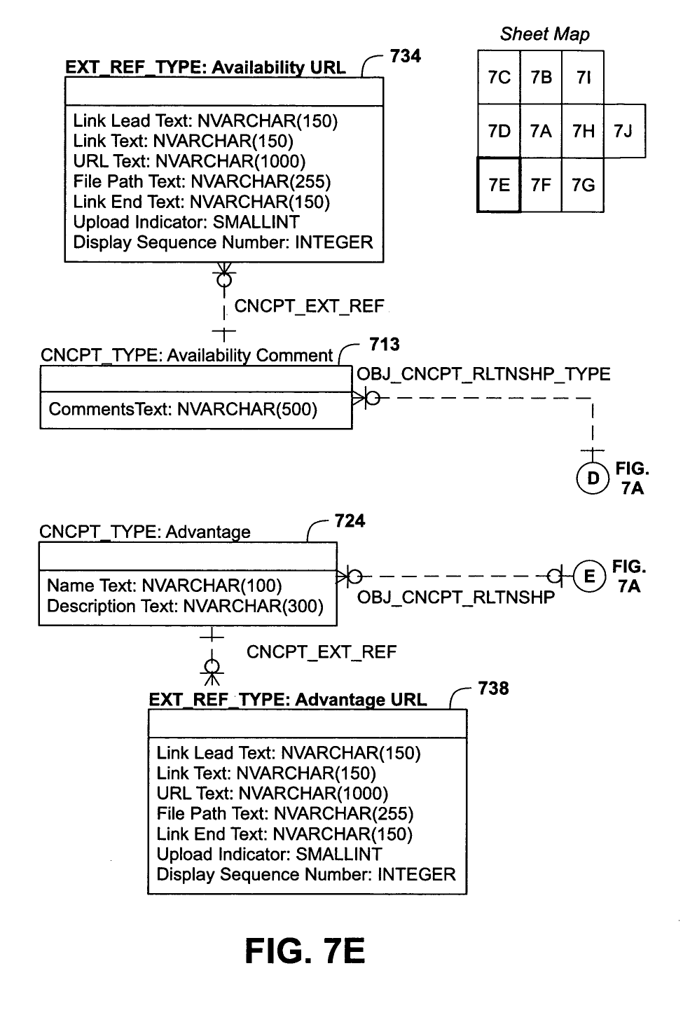

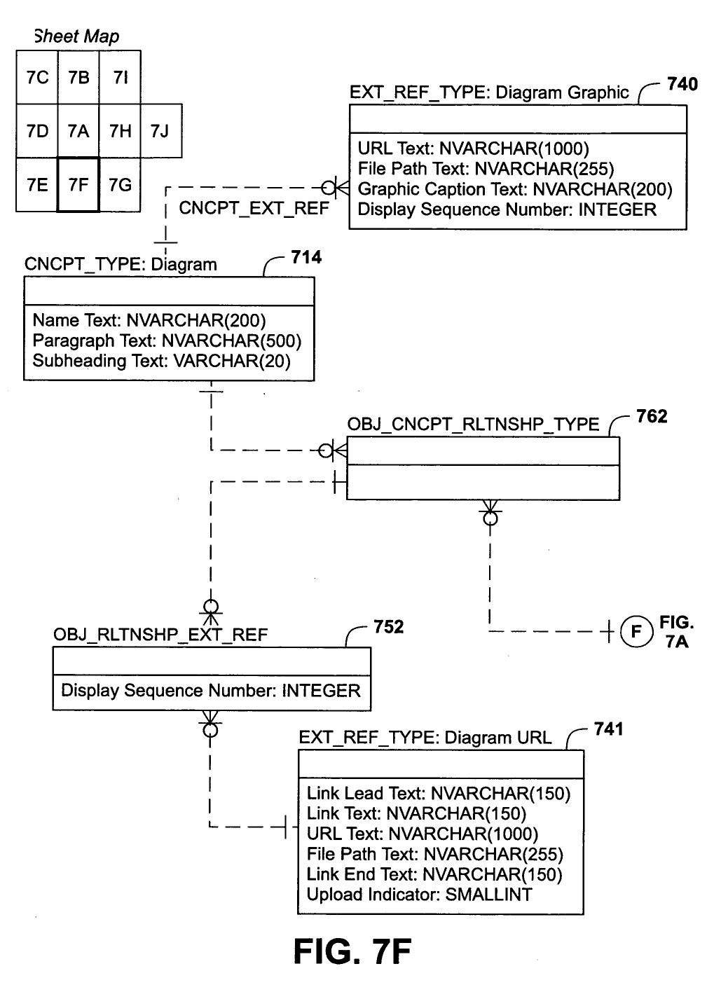

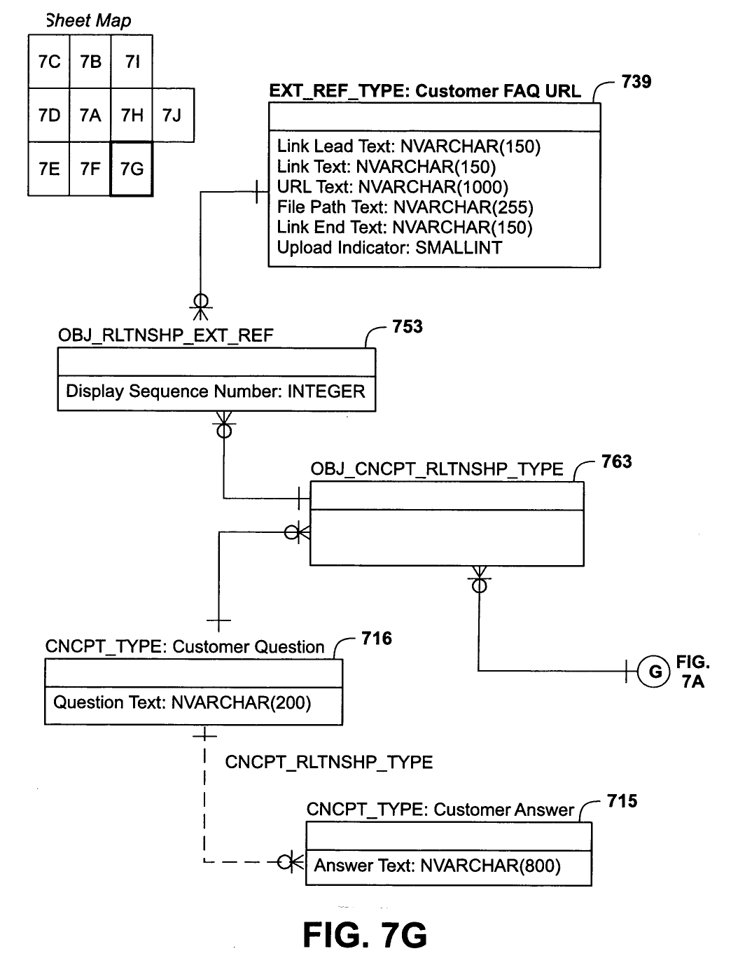

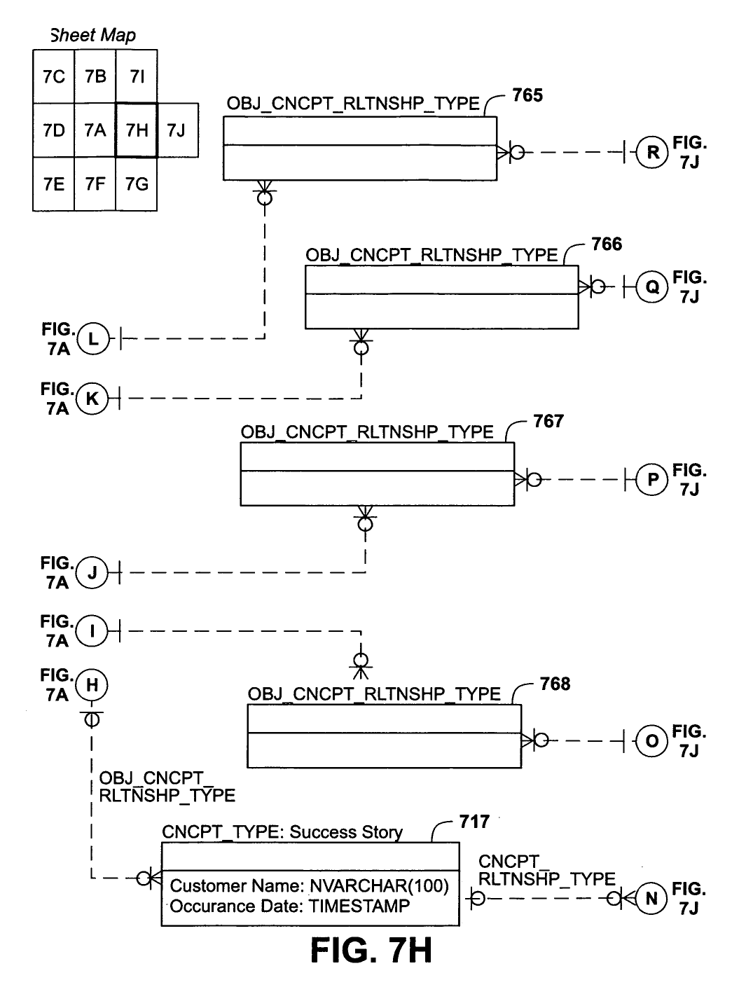

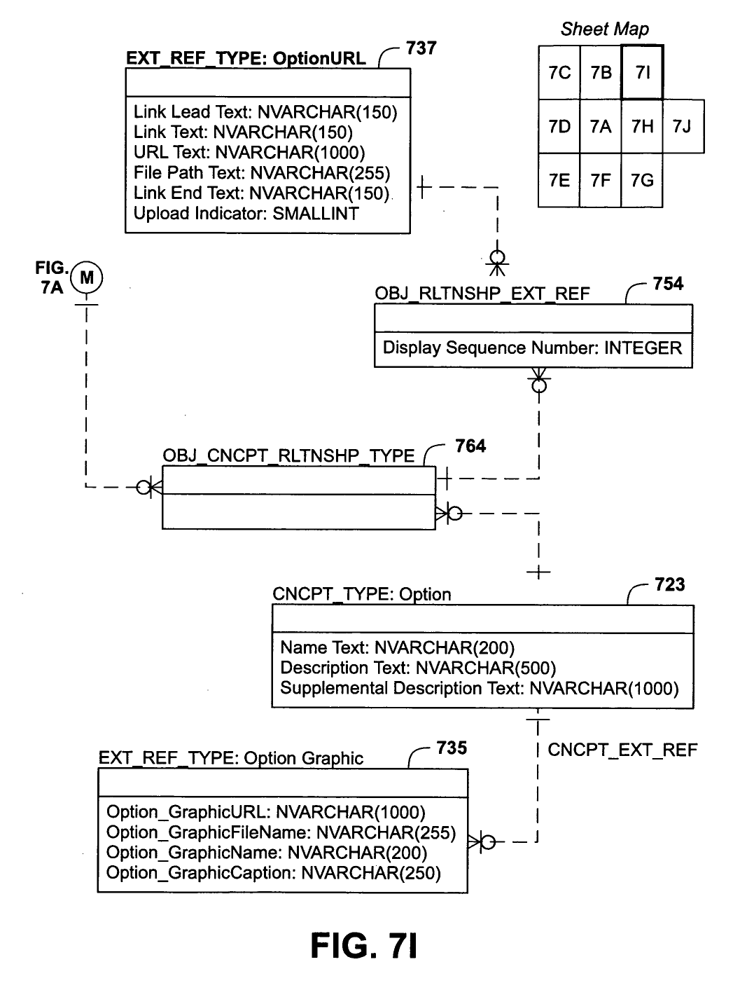

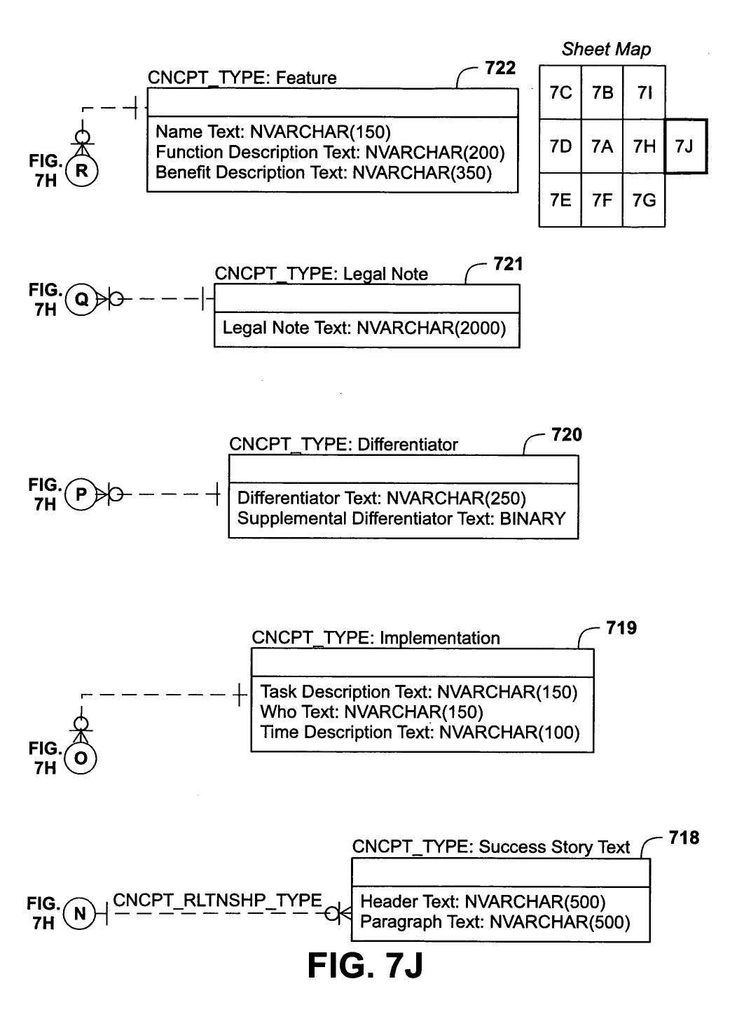

FIGS. 7A-7J provides a liquid content meta-rules mapping model schema with additional flexibility. An additional benefit of combining liquid content with discourse object data design is that “essential” conceptual components of the descriptive content can be represented as extremely flexible abstract constructs.

In the explicit data design of FIGS. 6A-6O data objects were classified by conceptual taxonomy such as a product. In FIGS. 7A-7J a type of object of interest such as “Product” can be viewed as an instance of the abstract construct “Discourse Object Type.” An instance of “Product” might be a “Computer Monitor XYZ” and can be viewed as an instance of the abstract construct “discourse object”. Discourse Objects can be described by instances of the abstract construct “concept type”. An instance is generally defined as object that contains all of the properties and methods of a particular class. In accordance with the teachings herein, discourse object data design may represent the essential conceptual components of description-descriptive content information as extremely flexible abstract constructs. For example “Product,” can be viewed as an instance of the abstract construct “Discourse Object Type.”

In FIG. 7A, DSCRC_OBJ_TYPE: Product table 702 illustrates such an abstract construct where the links illustrate a relationship type between the object and the concept. Similarly, as illustrated in FIG. 7J, the concept type tables Feature 722, and Differentiator 720 can be viewed as instances of the abstract construct, “Concept Type.” Additionally, Option Table 723 on FIG. 7I can be viewed as an instance of the abstract construct “Concept Type.”

Likewise, in FIG. 7I concept type table Option 723, concept table Option Graphic 735 and external reference type table User Guide 740 on FIG. 7A, and external reference type table, Advantage URL 738 on FIG. 7E can be viewed as instances of the abstract concept “External Reference Type.”

Thus, tables can be separated or organized by the meaning that they can provide to content. For example the DSCRS_OBJ_TYPE: Product table 700 provides discourse object types, while concept tables 710-724 define the concept types. External reference type tables 730-741 may define different types of external references, while external reference tables 750-754 may define subjects associated with the external reference tables and object concept relationship type tables 760 -768 may define discourse object-concept relationship types.

This organization and association provides an increased level of abstraction, because discourse objects from the explicit data design become instances of a higher level of abstract data objects. The meta-rules mapping model diagram disclosed in FIGS. 7A-7J is similar to the explicit model of FIGS. 6A-6J, but the tables, relationships and columns are translated into the types of abstract ideas that correspond to the abstract concept taxonomy described with reference to FIGS. 6A-6J and other figures herein.

One feature of the abstract conceptualization, is that a clear distinction between rules and instances is maintained in the data architecture. In this meta-rules mapping model, concept type tables 710-724 contain instances of types of concepts such as “Options,” “Features,” “Success Stories” etc. In the explicit model of FIGS. 6A-6J, the rows in the “Option” tables are instances of the concept type “Option.”

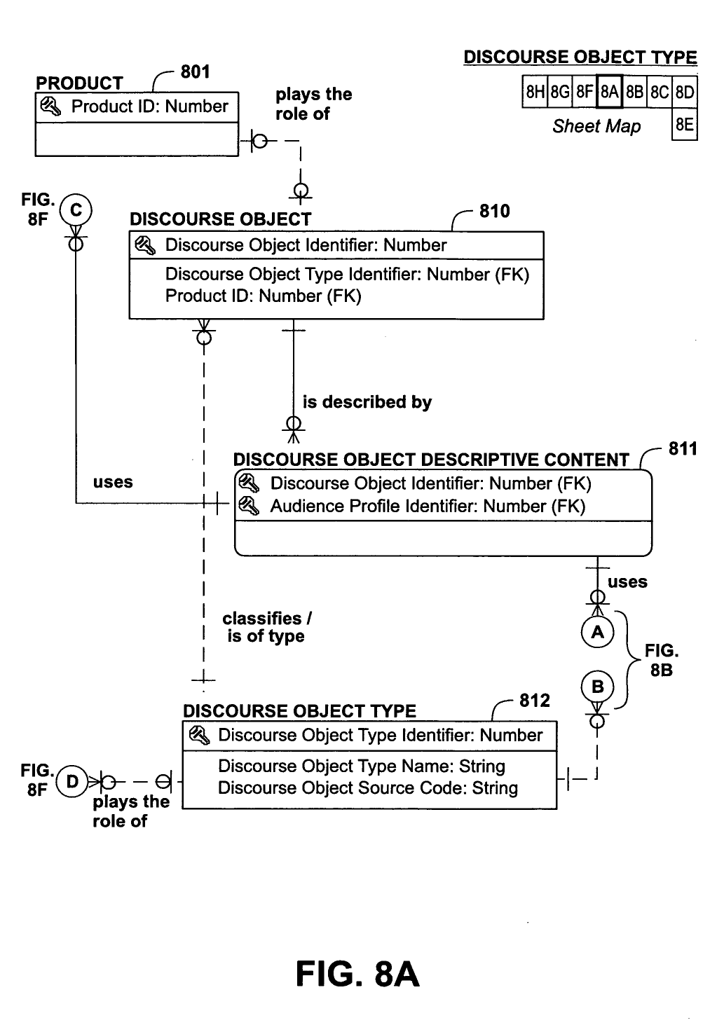

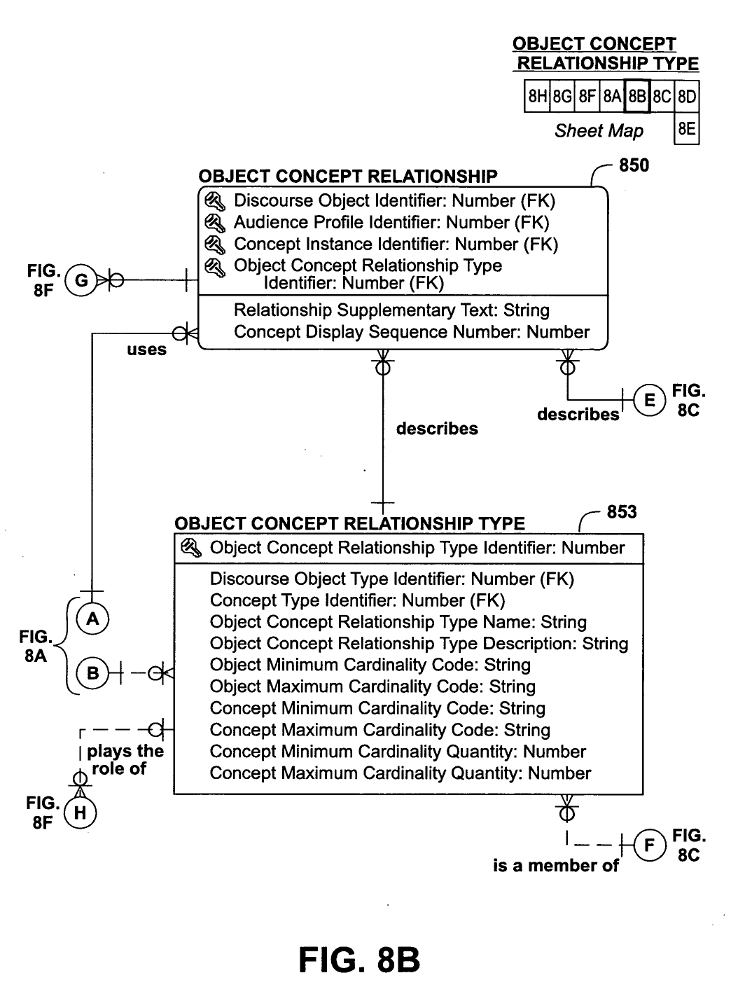

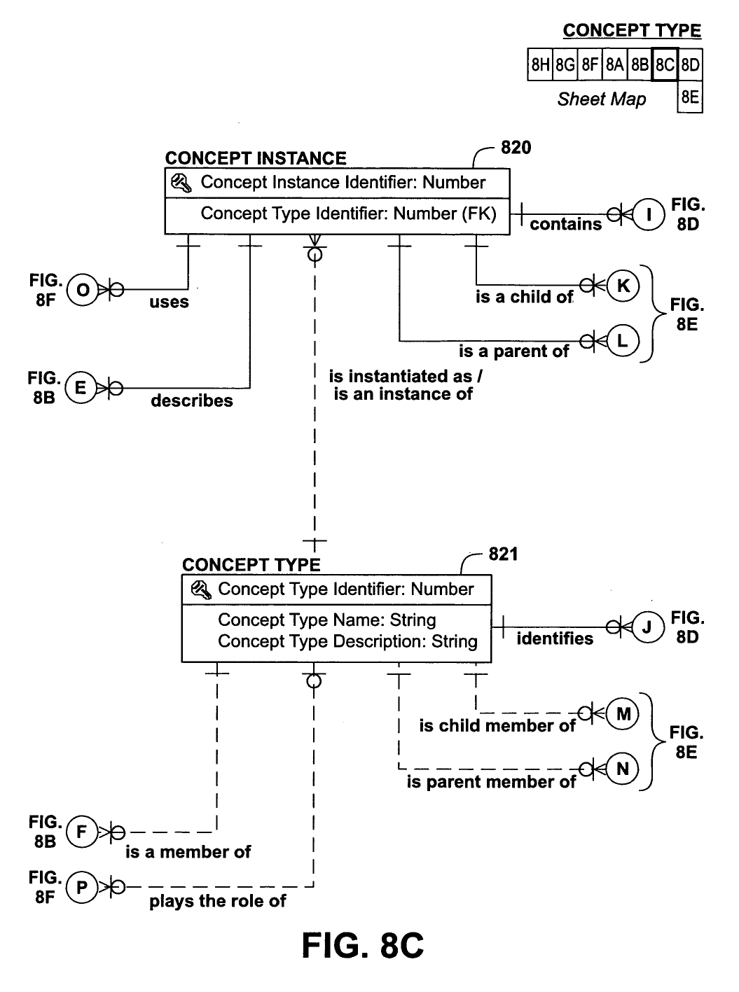

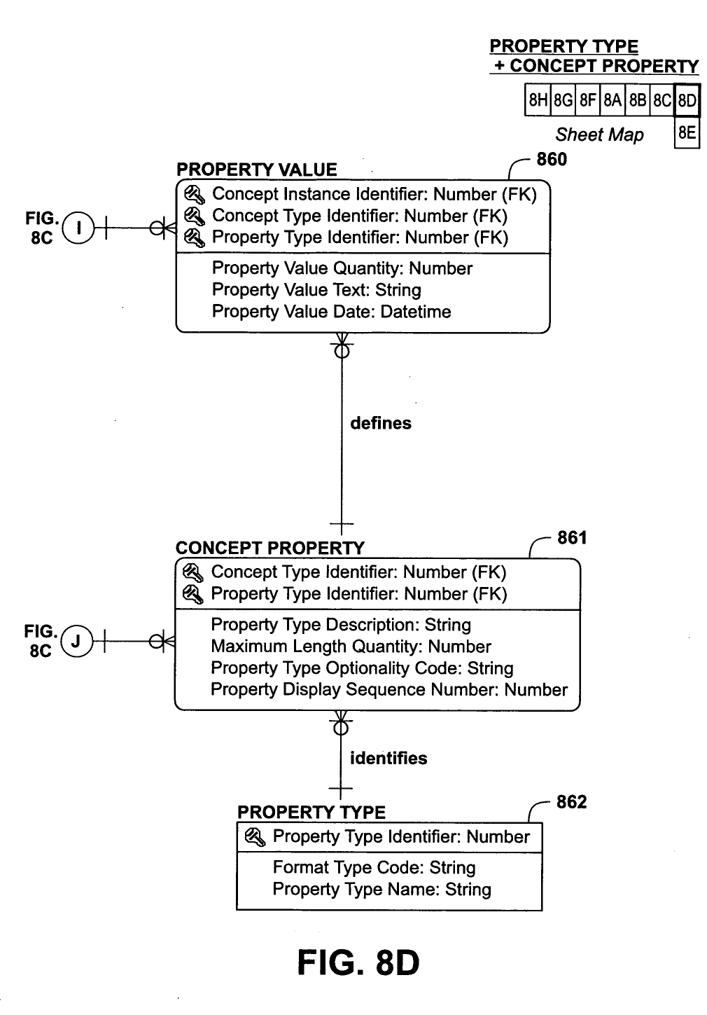

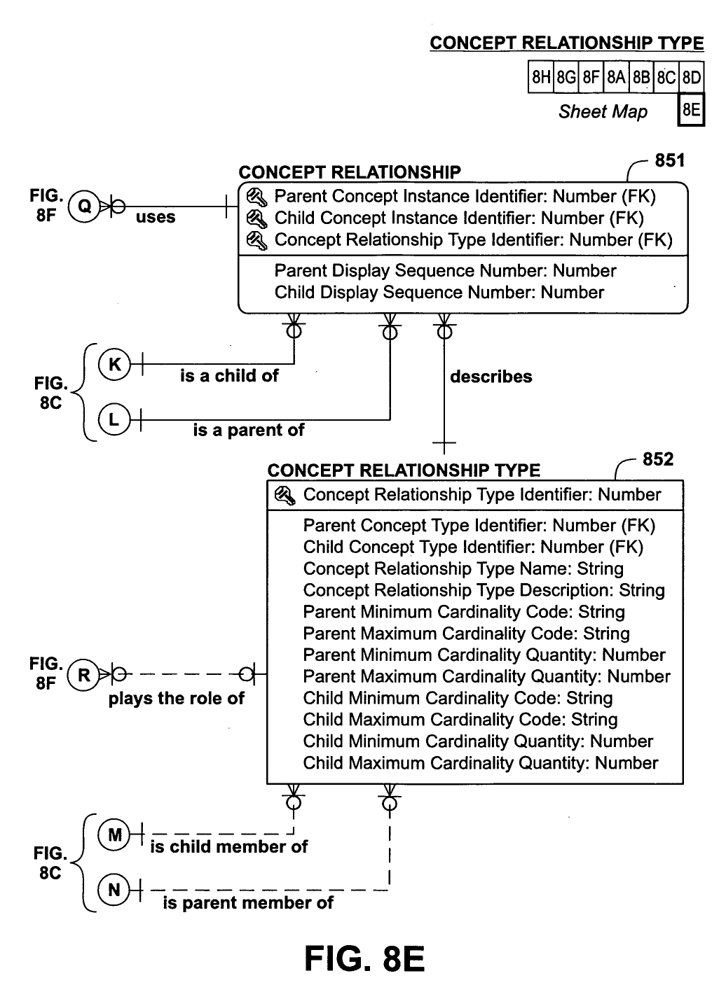

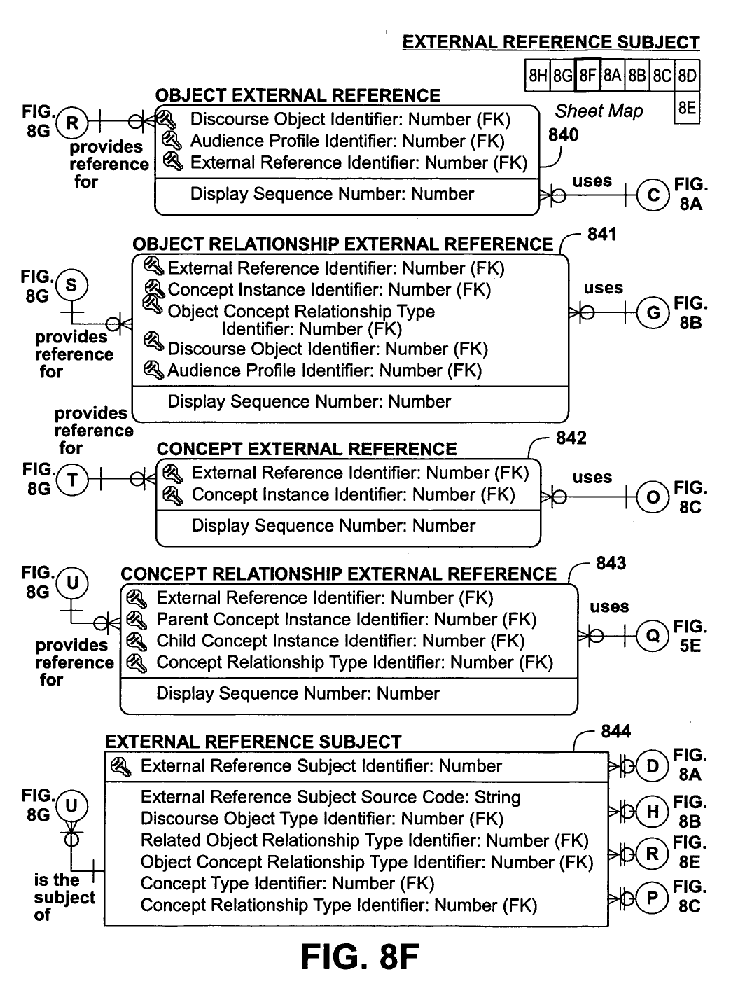

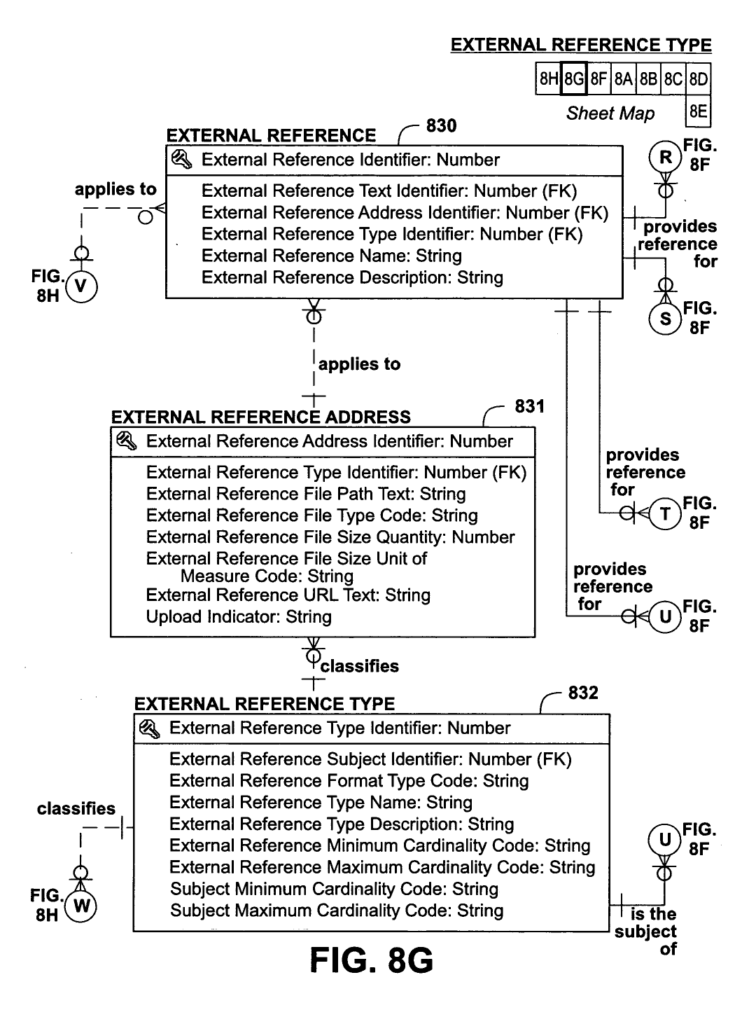

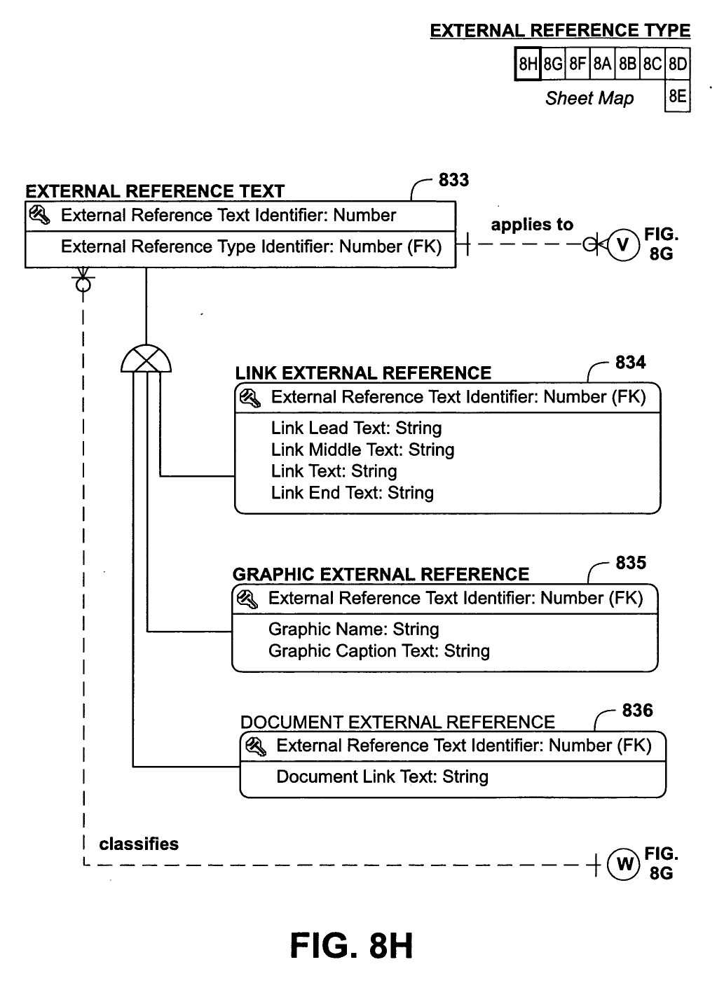

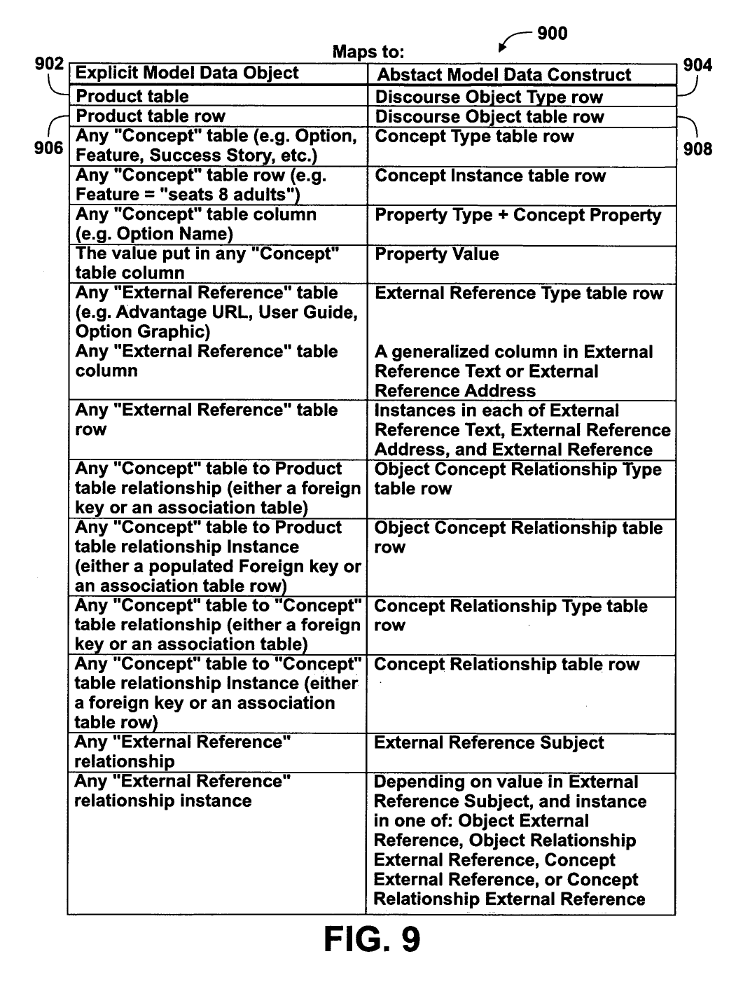

FIGS. 8A-8H provide an exemplary embodiment disclosing a subset of a discourse object logical explicit data model-mapping configuration. The model discloses how data objects in the explicit data architecture can be mapped into constructs in a liquid content abstract data architecture. A construct can generally be thought of as an abstract or general idea inferred or derived from a specific instance. Objects or units in the explicit model of FIGS. 7A-7J can be mapped directly to constructs in the abstract model of FIGS. 8A-8H. Referring briefly to FIG. 9, a table 900 illustrates how data units in the explicit model can be mapped to the abstract model to create the data model mapping configuration of FIG. 8A-8H.

The table 900 provides generally, a summary of transformations (to a higher level of abstraction) that can be made from the explicit data architecture to the abstract architecture. For example, model object “Product table” 902 may map to “Discourse object type row” 904. Thus, the entire “product table” 902 (a.k.a. 700 in FIG. 7A) can be represented as an abstract concept in a row of the discourse object type table 812 of FIG. 8A. Hence, a product listed in the product table can be moved to a higher level of abstraction when it is placed in a row in a mapped database.

In another example, “Product Table row” 906 (which may have been a row in the product table 700 in FIG. 7A) is associated with the abstract construct “Discourse Object table row” 908. Constructs that appear in the actual structure of an explicit data architecture may be represented in the data population of the corresponding abstract data architecture. Thus, moving constructs into a data population provides a higher level of abstraction and a more efficient use of the database.

In FIGS. 8A-8 J, examples of data values, that may be utilized to implement a simplified explicit data architecture example can generally be divided into three classifications: concept type, property type, and external reference type. Alternately described, the database can be viewed conceptually as having three types of tables; concept; property; and external reference tables.

For example, concepts from concept type table 821 in FIG. 8C could include an entries such as an advantage, an application, an availability, a comment, a component, a customer answer, a customer question, a diagram, a differentiator, a feature, a how does it work, an implementation, a legal note, an opinion, and a success story. Entries or retrieval of properties from property type table 861 on FIG. 8D may include bridge text, comments text, advantage text, description text, how text, name text, an occurrence date, paragraph text, and why text. Likewise entries or retrievals from external reference type table 832 may include an Advantage URL, Application Graphic, Application URL, Availability URL, Customer FAQ URL, Component URL, Diagram Graphic, Diagram URL, How Does It Work URL, Option Graphic, Option URL, User Guide, and White Paper.

From a top down perspective product table 801 in FIG. 8 A is related to discourse object tables 810-812. Discourse object tables 810-812 have relationships with concept type tables 820 and 821, external reference type tables 830-836, external reference subject tables 840-843, object concept relationship type tables 850-853, property type and concept type tables 860-862. The tables and the links generally provide a liquid content abstract data object design that represent types of data objects in an explicit data architecture utilizing corresponding mapping diagrams.

The abstractions in FIGS. 8A-8H illustrate a flexible, efficient, and robust configuration for storing content for reuse utilizing twenty six (26) tables to organize, store and link the data with meta data. Thus, data objects in the explicit data architecture can be mapped into constructs in a liquid content abstract data architecture by using such a configuration. The tables are organized by type (concepts, properties, and external) based on the rules structure and this database schema provides a flexible and efficient architecture for adding new objects and properties. The “Product table 801” in FIG. 8 is merely an example of one possible user defined data object. For example, “people,” “planets” or “countries” could be a user defined discourse object.

The meta-rules mapping example of FIGS. 7A-7J provide a useful graphical means of representing structure that is “hidden” in the abstract population of FIG. 8A-8H. The configuration of FIGS. 7A-7J contains the majority of the information necessary to provide the meta rules mapped configuration. The level of abstraction provided in FIG. 8A-8H is advantageous because adding and changing descriptive content facts (properties) can be efficiently done. With this level of abstraction, the “minimized” or “atomic” rhetorical units that have meaning can be classified and linked to hundred or thousands of discourse objects to form a sentence with minimal user input. A further advantage of the meta rules mapping configuration (FIGS. 8A-8H) is that the size of the database is greatly reduced from conventional configurations. The “multi-use” or “reusable” rhetorical units such as properties and concepts can be stored at a high level of abstraction and be assembled or reassembled into a meaningful and quality sentence with less processing overhead.

In summary, the explicit architecture of FIGS. 7A-7J is a manageable configuration for a single discourse object because a single discourse object may have fifteen (15) concept types implemented by forty-three (43) tables. However, when dozens of discourse objects are required, each discourse object having multiple tables requiring hundreds of interrelated tables, the liquid content abstract mapped architecture may be a superior approach even assuming many shared concepts. The liquid content abstract mapped data architecture of FIGS. 8A-8H implements substantially identical constructs as FIGS. 7A-7J and can perform the same function as the embodiment illustrated in FIGS. 7A-7J with a reduced number of tables (twenty-one in the illustration).

Discourse Objects and “relate-able” descriptive concepts and properties could correspond to anything someone is capable or conceiving. In accordance with the present disclosure, no matter how many new discourse objects need to be defined or how many new types of descriptive facts are added changed or deleted over time, the abstract data architecture may continue to manage this new and additional information with a fixed set of tables.

For example, the embodiment illustrated by FIGS. 8A-8H can utilize the same twenty-one (21) tables to accommodate new or additional discourse objects and hundreds or thousands of new and additional supporting data entries such as facts. The data structure is very flexible because it can remain substantially unchanged during growth. Requirements for entirely new kinds of information can be met by simply adding data or new values into the existing rules tables.

An application built on the “rules based” abstract architecture that is designed to fully leverage its meta-model flexibility may likewise be resilient and accommodating to change over time and support things to be described possibly with all popular descriptions know in the industry. If a data structure driven design is employed based directly on the abstract data structures, a very small set of generalized application code components may be constructed which can accommodate nearly all of the evolving database entry requirements. The changes are merely reflected as modifications or additions to the abstract rules table populations

While discourse objects can be considered an abstraction within a liquid content format, types of discourse objects may actually correspond to “things of interest” in the real world and the things of interest may actually be defined in other remotely located databases. The liquid content abstract data architecture disclosed also allows objects to be defined outside of the database and implemented in any user-defined database. The outside objects can be “plugged in” and treated in a common way with existing entries such that there is virtually no structural impact on the liquid content database architecture.

In addition to the actual liquid content constructs, the liquid content data model may provide an understandable example of a user-defined database. The liquid content data model described above demonstrates how various things of interest to a hypothetical user can be represented as discourse objects and how multiple databases can interact. Many different objects defined in a “Product database” can act in the role of discourse objects in the liquid content database. For example, “product,” “product promotion,” and “product grouping” can define a “product database.” Additionally, any number of user-defined databases, potentially representing diverse business subject areas, could interface with the liquid content database simultaneously.

Another feature of the liquid content abstract data design is the flexibility and extensibility when focused on a single purpose, to identify a discourse object and classify and store descriptive facts about the discourse object. Much of the complexity in business databases is in the complex rules between discourse objects. This problem is greatly reduced by the user-defined liquid content data model provided herein.

In the embodiments above data structures are implemented to support rules about: 1) the relationships between product groupings and products, 2) relationships between product promotions and products, 3) and flavors of products including individual products and packages (via Product Type), etc. However, the liquid content abstract data design can provide a mechanism for defining simple relationships between types of discourse objects for descriptive content purposes only (Related Object Relationship). The method can assume that user-defined databases external to the main database will have full responsibility for managing complex inter-discourse object business rules.

In an explicit data architecture, a great deal of information and meaning can be embedded in data names, making data inaccessible and requiring data to be buried in application code or replicated as hard coded labels on input screens or outputs. For example, in the explicit data design above, “Feature” (a Concept type) and “Product” (a Discourse Object type) are table names, and “Function_Description” and “Benefit_Description” are names of columns (Properties) in the “Feature” table. However, in the abstract data design of FIG. 8A-8J these are all facts that are implemented as rows in abstract tables and are therefore accessible as data. As such, they are data elements that can be displayed in pull-down lists or as dynamic labels, significantly enhancing the robustness and simplifying the application layer required to implement the system and method.

There are real-world facts that often naturally appear as descriptive content components themselves in assembled outputs. For example, section or paragraph headings can be considered as real world facts. Furthermore, other meta-data facts, such as data element lengths and data types (e.g. in the illustration Benefit Description is alphanumeric and 350 characters long), and relationship cardinalities are all accessible as data facts that can be used by the generalized and dynamic application design provided herein.

A feature of the present disclosure is to allow descriptive facts about discourse objects to be qualified based upon audience and other contextual characteristics (such as language), without altering the fundamental meaning of the content produced. For example, using the “Product” example, the nature of a comprehensive description for a particular product might be very different for a highly technically sophisticated audience versus a relatively unsophisticated general audience, both in terms of the quantity of the information presented and the tone with which it is written. On the other hand, while the overall structure of the message being presented as descriptive content may not vary, the different languages (e.g. English vs. Spanish vs. Italian) can provide a radically different format.

Assuming that there are 300 data elements, this equates to 600 data elements just to represent a single differentiating audience factor. The structural size of the database would double, while pushing knowledge about the data factor out into the application code.

Adding additional factors of the same type (e.g. German) expands the structural size of the database geometrically, but managing all the permutations of multiple types of factors that collectively describe an audience (e.g. Spanish speaking and Technically Sophisticated and located in Texas, and . . . ) potentially expands logarithmically both the size of the database structure and the complexity of the application code needed to manage it. In effect, robust audience differentiation also cannot be achieved with a conventional explicit data architecture.

The liquid content abstract data architecture described in reference to FIGS. 8A-8H can provide audience differentiation without an additional structure in the database. The audience differentiation can be implemented in a very straightforward manner by using the conceptual decoupling and abstraction described above.

Numerous audience factor data structures can be user defined in the logical database. For example, a language type data structure, a geography data structure, a technical level data structure, and an informal language data structure could accommodate nearly every language variation imaginable.

Additionally, various groupings or factors may be combined into audience profiles (e.g. Spanish-speaking, retail customer, in California) and merged into a single table. These profiles can be utilized to differentiate the contents of types of descriptive facts (e.g. Benefit Description) and the way those facts are assembled as descriptive content by creating tables links between tables and fields within the tables.

Furthermore, a data object that is defined outside of the liquid content database and implemented in a user-defined database can be “plugged in” to the liquid content database and treated as an audience factor with virtually no structural impact to the liquid content database. In one embodiment, audience factors can be defined as data and can be accessible and useable by the application layer as labels and selection parameters. As disclosed numerous audience factors or new combinations of factors can be added without altering the liquid content data structure. The additional factors can be added as values in liquid content meta-rules tables.

In accordance with the teachings of the present invention, content can be captured and stored in a liquid content format as meaningful, discrete, descriptive facts. The facts can be stored independent of their use in any specific discourse object or media or particular technology. In accordance with one configuration, descriptive content elements such as descriptive facts can be reusable or repurposed for multiple presentations. For instance, two Products (e.g. automobile tire styles A and B) can have the very same “Benefit Description” (e.g. high traction in wet conditions). Facts may be captured in the liquid content abstract data architecture as “Property Values” for instances of “Concept Types,” or as instances of “External References.” Either way the facts can be stored independently, and then assigned to particular “Discourse Object instance.” As a result, descriptive facts can easily be written once, then re-used many times for many different discourse objects. Furthermore, because in the liquid content data architecture data rules are clearly differentiated from data instances, rules governing re-use can be easily defined and employed in the content management application. For example, a rule may be an instance of a feature or concept type and may be shared between different products or discourse object types.

Alternately, instances of options or concept types may not be shared between different product types. Individual specialized data mechanisms may have to be added to the database and specialized application code may be required for every discrete data objects (i.e. hundreds or thousands of data objects). For example, while “Feature” and “Option” are conceptually similar in that there are types of “Concepts,” physically they can be independent objects (stored in independent tables in the database) achieving a high level of content re-use.

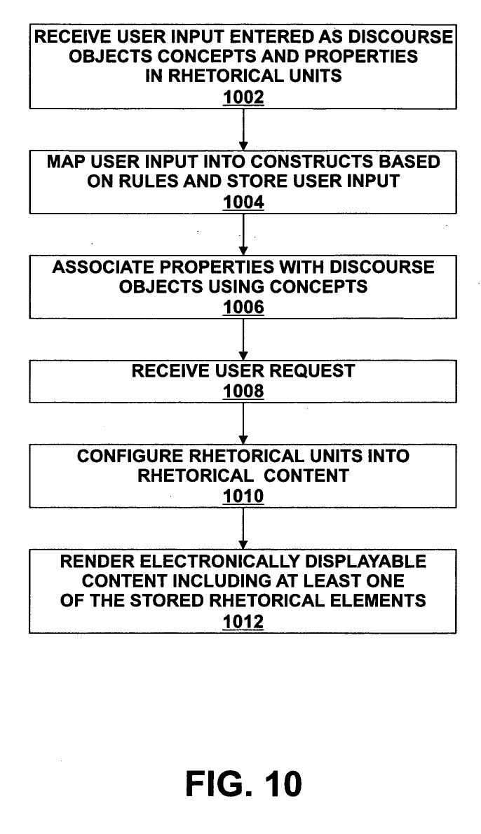

FIG. 10 is an exemplary flow diagram illustrating a method of providing reusable rhetorical content. As illustrated by block 1002 user input is received. The user input may be a discourse object, a concept, a property, or any other supporting materials. The user input may also be information on how to link or relate new or existing entries within the system. As illustrated by block 1004 the user entries are mapped into constructs having higher levels of abstraction. This can be accomplished in accordance with rules and in accordance with the Abstract Model Data Constructs of FIG. 9 (the right column).

The discourse objects, concepts, and properties may be stored as atomic rhetorical building blocks and linked and organized according to their meaning. Associations are created between the tables and the fields as illustrated by block 1006.

A user request for content can be received as illustrated by block 1008 and the stored rhetorical units can be configured to form rhetorical content as illustrated at block 1010. Electronically displayable content can be rendered as illustrated by block 1012.

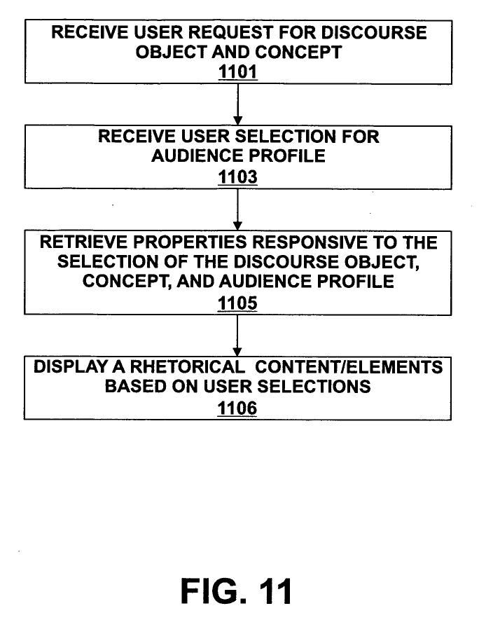

FIG. 11 is a flow diagram of a method for storing and organizing rhetorical content in a database utilizing a higher level of abstraction and providing a distinction between rules and concept instances. A user request for building rhetorical content is received as illustrated at block 101. The user request can be made for a discourse object and a concept type. A user selection for audience profile may also be received as illustrated by block 1103. Based on the user request, the predetermined rules, and concept instances, properties are retrieved from a database as is illustrated at block 1105. The rhetorical content is then created and displayed responsive user input, rules, instances and links that exist with the database as is illustrated at block 1106.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A data storage system comprising:
a memory configured to store objects including at least one discourse object, at least one concept, and at least one property, the property having a rhetorical structure that is linkable to the discourse object via the concept;
a mapping table to provide a mapping configuration for mapping a stored object to a construct in an abstract data architecture.

2. The data storage system of claim 1, wherein the discourse object, concept, and property from an explicit data architecture are mapped into constructs in a liquid content abstract data architecture based on rules such that the level of abstraction is increased.

3. The data storage system of claim 1, wherein the discourse object, concept and property are associated based on links and rules, and the rules are stored in rules tables and when new entries are added to the memory new instances are added to existing rules tables.

4. The data storage system of claim 1, wherein the selectable concept is one of a class of information from a plurality of classes of information, a meaning, a purpose, a persuasion, a conveyance, an intent, a concept, an example, an illustration, a testimonial a definition a description a comparison an emphasis, an inference, advantage, an application, an availability, a component, a customer answer, a customer question, a diagram, a differentiator, a feature, a how does it work, an implementation, an audience factor, a configuration, a opinion, a success story and a legal note.

5. The data storage system of claim 1, wherein the discourse object is one of an entity that can be described product, a promotion, a service, a product offering, a service offering, a package offering, a conceptual offering, an item, a customer, an employee, and a proposal.

6. The data storage system of claim 1, wherein the individual properties further include classes of attributes of discourse objects.

7. The data storage system of claim 1, wherein the linkable rhetorical structures can integrate atomic level rhetorical units to form at least one sentence having a rhetorical structure.

8. The data storage system of claim 7, wherein the rhetorical structure conveys a meaning, theme or idea and the selectable concepts are organized based on the meaning, theme or idea of the concept.

9. The data storage system of claim 1, wherein the plurality of properties is one of a comment, a description, an opinion, a testimonial, a name, a date, an event, a graphic, an occurrence, a difference, a how, a when, a why, a where, a what, a who and a selectable target audience profile.

10. The data storage system of claim 1, further comprising external source identifiers, the external source identifiers configured to locate one of a remotely located discourse object, a concept and a property.

11. A method of operating a database comprising;
storing concepts that can facilitate providing rhetorical content, the concepts linking to a discourse object;
storing attributes a discourse objects in rhetorical units
linking the stored attribute to the discourse object in a relational database;
selecting a discourse object;
selecting a concept to be conveyed about the selected discourse object;
integrating the selected discourse object with the linked attributes based on the selected concept to produce rhetorical content.

12. The method of claim 11, further comprising displaying rhetorical content.

13. The method of claim 11, wherein stored concepts are linked utilizing rules and instances.

14. A method of assembling content comprising:
selecting a discourse object;
displaying a concept, the concept having a rhetorical theme to support the discourse object, the concept being an instance of the discourse object responsive to rules.
selecting a the concept;
locating a property utilizing links;
displaying grammatically correct content responsive to the selected discourse object the selected concept and the rules.

15. The method of claim 14, further comprising automatically displaying rhetorical content responsive to the selected discourse object and the selected attribute.

16. The method of claim 14, further comprising selecting a target audience and automatically providing rhetorical content based on the selected discourse object, the selected attribute and the selected target audience.

17. A method of structuring a database comprising:
storing a discourse object as a discourse object record;
storing at least one concept as a concept record;
storing at least one property as a property record; and
associating the property record with the discourse object record utilizing rules and links wherein a rhetorical content can be generated by selecting discourse object and a concept.

18. The method of claim 17, further comprising:
selecting a discourse object, and a concept utilizing a graphical user interface; and
automatically selecting properties responsive to the selection.

19. The method of claim 17, further comprising concatenating discourse objects with properties to form a rhetorical content.

20. The method of claim 17, wherein the discourse object is at least one of an entity that can be described, a customer, a product, a product promotion, a subject, a service, a service promotion, a technology, and an item.

21. The method of claim 17, wherein the at least one property provides one of a discrete fact, a description, a feature description, a benefit description, and an idea that describes the at least one concept.

22. The method of claim 17, wherein the at least on concept is one of a feature, class of information, a distinction, and a discrete fact.

23. The method of claim 17, wherein the discourse object, the at least one concept and the at least one property are stored in a rhetorical element format.

24. The method of claim 17, further comprising rendering electronically displayable media by assembling rhetorical unit of the discourse object, the at least one concept, and the at least one property.

25. A method of storing data comprising:
receiving a plurality of user content comprising property elements associated with at least one discourse object via a concept; and
storing the plurality of user content in data records organized by the discourse objects, the properties and the concept to provide rhetorical structure to facilitate selective assembly of the discourse object and the properties into at least one sentence based on selection of the concept;

26. The method of claim 25, further comprising:
converting at least a portion of the plurality of user content into a structured format file supporting rhetorical elements; and
rendering an electronically displayable document using the property elements, the content and the discourse object in a structured format file, the electronically displayable document including at least one grammatically structured sentence.

27. The method of claim 25, wherein the property elements have grammatically structured text elements, each of the plurality of grammatical structured text elements having a rhetorical structure to facilitate selective assembly of the discourse object and the properties into at least one sentence.

28. A database configured for content delivery comprising:
a server program configured to receive requests associated with a discourse object, the requests being received via a distributed network;
a rhetorical data file including a plurality of discourse objects, a plurality of properties of concepts, the concepts linking discourse objects to properties, the rhetorical data file having structured data to provide the properties and the discourse objects in portions of grammatical phrases; and
a concatenator responsive to the rhetorical data file, the concatenator configured to selectively construct content relating to the discourse object using at least one grammatical phrase structure from the set of grammatical phrase structures, the concatenator configured to deliver discourse objects and properties as content.

29. The content delivery application of claim 28, wherein the server program delivers the content via the distributed network.

30. The content delivery application of claim 28, wherein the rhetorical data file comprises XML coding.

31. The content delivery application of claim 28, wherein the content is constructed in accordance with an XSL file.

32. The content delivery application of claim 28, wherein the at least one grammatical phrase structure is selected from a group consisting of an item to be described, a product name, a product class, a description phrase, a differentiator phrase, and comparable product name.

33. The method of claim 31, wherein at least one of the plurality of rhetorical elements is associated with one of a class of attributes, a product description a definition, a product name, a product class, a product differentiator, a product functionality, a product feature, a first degree of technical content, a second degree of technical content, the second degree being greater in technical specificity than the first degree of technical content, a product benefit, a product comparative description.
